(19) United States
(12) Patent Application Publication
(10) Pub. No.: US 2024/0042421 A1
(43) Pub. Date: Feb. 8, 2024

(54) SRCC AS A CATALYTIC CARRIER FOR METAL SPECIES

(71) Applicant: OMYA INTERNATIONAL AG, Oftringen (CH)

(72) Inventor: Jamal FTOUNI, Zofingen (CH)

(73) Assignee: OMYA INTERNATIONAL AG, Oftringen (CH)

(21) Appl. No.: 17/753,942

(22) PCT Filed: Sep. 23, 2020
(86) PCT No.: PCT/US2020/076475

§ 371 Date: Mar. 18, 2022

(30) Foreign Application Priority Data
Sep. 26, 2019 (EP) 19199746.9

(51) Int. Cl. B01J 27/232; B01J 37/02; B01J 37/08; B01J 37/18; B01J 37/00; B01J 23/745; B01J 23/755; B01J 23/72; B01J 23/46; B01J 23/44; B01J 23/42; B01J 23/52; B01J 35/10; B01J 35/00; C07C 51/23; C07C 29/60

(52) U.S. Cl. CPC B01J 27/232; B01J 37/0207; B01J 37/088; B01J 37/18; B01J 37/0018; B01J 23/745; B01J 23/755; B01J 23/72; B01J 23/462; B01J 23/44; B01J 23/42; B01J 23/52; B01J 35/1014; B01J 35/1019; B01J 35/0066; C07C 51/23; C07C 29/60

(57) ABSTRACT

The present invention refers to a catalytic system comprising a transition metal compound on a solid carrier, wherein the content of the transition metal element on the surface of the solid carrier is from 0.1 to 30 wt.-%, based on the dry weight of the solid carrier. Furthermore, the present invention refers to a method for manufacturing the catalytic system, the use of the inventive catalytic system in a chemical reaction, the use of a solid carrier loaded with a transition metal as a catalyst and to granules mouldings or extrudates comprising the catalytic system.

The present invention refers to a catalytic system comprising a transition metal compound on a solid carrier, wherein the content of the transition metal element on the surface of the solid carrier is from 0.1 to 30 wt.-%, based on the dry weight of the solid carrier. Furthermore, the present invention refers to a method for manufacturing the catalytic system, the use of the inventive catalytic system in a chemical reaction, the use of a solid carrier loaded with a transition metal as a catalyst and to granules mouldings or extrudates comprising the catalytic system.

Catalyst or catalytic systems comprising a carrier and a catalyst are widely used in catalysis and have several advantages. For example, the handling of such catalytic systems and also the isolation of reaction products is less expensive compared with homogeneous systems. Furthermore, the activity and efficiency of a catalytic system in a given reaction may be controlled by selecting specific structural properties of the carrier or a specific transition metal.

Elemental transition metals and corresponding compounds, such as transition metal salts, oxides or complexes, are well-known catalysts and may be applied in a number of reactions, for example in alkene or alkyne hydrogenation or in epoxidation. Some of the most frequently used transition metals include platinum, palladium and copper.

Common support materials for heterogeneous transition metal catalysis are activated carbon, carbon black/graphite, alumina, barium sulphate and calcium carbonate (The Catalyst Technical Handbook, Johnson Matthey Co., 2005).

For example, U.S. Pat. Nos. 5,965,480 and 5,703,254 disclose the direct oxidation of propylene to propylene oxide using silver catalysts on alkaline earth metal carbonate-containing carriers, such as calcium carbonate, to catalyse selectively the formation of epoxides.

WO 2004/030813 A1 relates to a process for preparing a catalyst which involves (a) preparing a paste having a uniform mixture of at least one alkaline earth metal carbonate, a liquid medium, a silver bonding additive, and at least one extrusion aid and/or optionally a burnout additive; (b) forming one or more shaped particles from the paste; (c) drying and calcining the particles; and (e) impregnating the dried and calcined particles with a solution containing a silver compound. Said alkaline earth metal carbonate may be calcium carbonate.

WO 2013/190076 A1 relates to a catalytic system, which is a Lindlar type catalyst, wherein the support material (calcium carbonate) has an average particle size (d50) of more than 10 μm. It further discloses the use of such a catalytic system for the partial hydrogenation of a carbon-carbon triple bond to a double bond. Specific examples of carrier materials include precipitated calcium carbonate.

However, transition metals are only rare available in natural resources and, therefore, high costs for procurement and recycling, if possible at all, incur. Another drawback is the toxicity of transition metals and corresponding salts and, therefore, the catalyst loadings in transition metal-catalysed reactions should be kept as low as possible. Accordingly, there is a continuous need for the improvement of catalytic systems to overcome one or more of the aforementioned drawbacks.

One object of the present invention may therefore be seen in the provision of a more efficient catalytic system, which allows to reduce the catalyst loading during catalysis and the overall consumption of transition metals and allows to obtain a specific compound, i.e. a product with high selectivity. A further object of the present invention may be seen in the provision of a time-saving catalytic system with higher turnover rates. Yet one further object may be seen in the provision of an easily recyclable catalytic system to reduce the overall consumption of transition metals. One further object may therefore be seen in the provision of a more environmentally compatible catalytic system. Finally, one further object of the present invention may be seen in the use of a carrier obtained using a sustainable chemical process, starting from sustainable sources such as calcium carbonate.

The foregoing and other problems may be solved by the subject-matter as defined herein in the independent claims.

A first aspect of the present invention relates to a catalytic system comprising a transition metal compound on a solid carrier, wherein
a) the solid carrier is a surface-reacted calcium carbonate, wherein the surface-reacted calcium carbonate is a reaction product of natural ground calcium carbonate or precipitated calcium carbonate with carbon dioxide and one or more H3O+ ion donors, wherein the carbon dioxide is formed in situ by the H3O+ ion donors treatment and/or is supplied from an external source; and
b) wherein the transition metal compound is selected from the group consisting of elemental Ni, elemental Ru, elemental Au, elemental Pd, elemental Pt, elemental Fe, elemental Cu and mixtures thereof;
and wherein the content of the transition metal element on the surface of the solid carrier is from 0.1 to 30 wt.-%, based on the dry weight of the solid carrier.

The inventors of the present application surprisingly found that the use of surface-reacted calcium carbonate (SRCC) as catalyst carrier in transition metal catalysis, wherein the transition metal compound is selected from the group consisting of elemental Ni, elemental Ru, elemental Au, elemental Pd, elemental Pt, elemental Fe, elemental Cu and mixtures thereof provides several advantages.

First of all, surface-reacted calcium carbonate is a reaction product of ground natural calcium carbonate (GNCC) or precipitated calcium carbonate (PCC) treated with CO2 and one or more H3O+ ion donors, wherein the CO2 is formed in situ by the H3O+ ion donors treatment. Additionally or alternatively, CO2 may be supplied from an external source. Because of the reaction of GNCC or PCC with CO2 and one or more H3O+ ion donors, SRCC comprises ground natural calcium carbonate (GNCC) or precipitated calcium carbonate (PCC), and at least one water-insoluble calcium salt other than calcium carbonate resulting from the foregoing reaction. Said material has specific surface properties and was found to be surprisingly useful as carrier material in catalysis.

In combination with the above mentioned transition metal compound, for example, higher catalytic activities, for example higher glycerol transformation under inert atmosphere, hydrogen or oxygen were achieved with the catalytic systems according to the present invention. Moreover, the inventive catalytic system was easier to recover and higher yields were achieved, for example, in a second catalytic cycle compared with conventional carrier systems.

Another aspect of the present invention relates to a method for manufacturing a catalytic system comprising a transition metal compound on a solid carrier, the method comprising the following steps:
(a) providing at least one solid carrier, wherein the solid carrier is a surface-reacted calcium carbonate, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source;
(b) providing at least one transition metal reagent comprising Ni ions, Ru ions, Au ions, Pd ions, Pt ions, Fe ions, Cu ions and mixtures thereof in such an amount that the amount of said ions is from 0.1 to 30 wt.-%, based on the dry weight of the solid carrier;
(c) contacting the at least one solid carrier provided in step (a) and the transition metal reagent provided in step (b) to obtain a mixture comprising a solid carrier and a transition metal reagent; and
(d) calcining the mixture of step (c) at a temperature between 250° C. and 500° C.; and
(e) reducing the calcined catalytic system obtained from step (d) under H₂ atmosphere at a temperature between 100° C. and 500° C. for obtaining a catalytic system comprising a transition metal compound on the solid carrier, wherein the transition metal compound is selected from the group consisting of elemental Ni, elemental Ru, elemental Au, elemental Pd, elemental Pt, elemental Fe, elemental Cu and mixtures thereof.

The inventors surprisingly found that by the above method it is possible to provide a catalytic system wherein the transition metal compound that is selected from the group consisting of elemental Ni, elemental Ru, elemental Au, elemental Pd, elemental Pt, elemental Fe, elemental Cu and mixtures thereof is located on the solid carrier, which is a surface-reacted calcium carbonate. Furthermore, the above method is a cheap and simple production process which provides the inventive catalytic system.

Another aspect of the present invention refers to the use of the inventive catalytic system in a process comprising the following steps:
(A) providing one or more reactants;
(B) providing the inventive catalytic system;
(C) subjecting the one or more reactants provided in step (A) to a chemical reaction under air, O₂ atmosphere, H₂ atmosphere, or inert atmosphere at a temperature between 75 and 300° C. in the presence of the catalytic system provided in step (B).

Another aspect of the present invention refers to the use of a solid carrier according to the present invention loaded with a transition metal compound according to the present invention as a catalyst.

Finally, another aspect of the present invention refers to granules, mouldings or extrudates comprising the inventive catalytic system.

It should be understood that for the purposes of the present invention, the following terms will have the following meanings:

A “catalyst system” or “catalytic system” in the meaning of the present invention is a system that increases the rate of a chemical reaction by adding such a substance/compound/system to the reactants (compounds that are converted during the reaction), wherein the substance/compound/system is not consumed in the catalysed reaction and can continue to act repeatedly. The chemical reactions occurs faster or has an improved yield in the presence of such a catalytic system because it provides an alternative reaction pathway with a lower activation energy than the non-catalysed mechanism.

A “transition metal reagent” in the meaning of the present invention is a reagent that comprises a transition metal in oxide or ionic form. A “transition metal compound” in the meaning of the present invention is a compound that comprises a transition metal in elemental form. A “transition metal” is any element in the d-block of the periodic table, which includes groups 3 to 12 on the periodic table.

A “solid carrier” in the meaning of the present invention is to be understood as a substance which may be loaded with a second substance (for example, transition metal compound) for the purpose of transporting said second substance to a target environment (for example, a reactor), for easily recuperating the catalytic system in the end of the process and for allowing a controlled size distribution of the metal species on the surface of the carrier in the preparation procedure. In the present invention the transition metal compound is located on the surface of the surface-reacted calcium carbonate.

“Ground natural calcium carbonate” (GNCC) in the meaning of the present invention is a calcium carbonate obtained from natural sources, such as limestone, marble, or chalk, and processed through a wet and/or dry treatment such as grinding, screening and/or fractionation, for example, by a cyclone or classifier.

“Precipitated calcium carbonate” (PCC) in the meaning of the present invention is a synthesised material, generally obtained by precipitation following a reaction of carbon dioxide and calcium hydroxide (hydrated lime) in an aqueous environment or by precipitation of a calcium- and a carbonate source in water. Additionally, precipitated calcium carbonate can also be the product of introducing calcium- and carbonate salts, calcium chloride and sodium carbonate for example, in an aqueous environment. PCC may have a vateritic, calcitic or aragonitic crystalline form. PCCs are described, for example, in EP 2 447 213 A1, EP 2 524 898 A1, EP 2 371 766 A1, EP 2 840 065 A1, or WO 2013/142473 A1.

A “surface-reacted calcium carbonate” according to the present invention is a reaction product of ground natural calcium carbonate (GNCC) or precipitated calcium carbonate (PCC) treated with CO2 and one or more H3O+ ion donors, wherein the CO2 is formed in situ by the H3O+ ion donors treatment and/or is supplied from an external source. A H3O+ ion donor in the context of the present invention is a BrØnsted acid and/or an acid salt.

The “particle size” of surface-reacted calcium carbonate herein is described as volume-based particle size distribution dx(vol). Therein, the value dx(vol) represents the diameter relative to which x % by volume of the particles have diameters less than dx(vol). This means that, for example, the d20(vol) value is the particle size at which 20 vol.-% of all particles are smaller than that particle size. The d50(vol) value is thus the volume median particle size, i.e. 50 vol.-% of all particles are smaller than that particle size and the d98(vol) value is the particle size at which 98 vol.-% of all particles are smaller than that particle size. The volume median particle size d50 was evaluated using a Malvern Mastersizer 2000 or 3000 Laser Diffraction System. The raw data obtained by the measurement are analysed using the Mie theory, with a particle refractive index of 1.57 and an absorption index of 0.005.

The “particle size” of particulate materials other than surface-reacted calcium carbonate herein is described by its distribution of particle sizes dx(wt). Therein, the value dx(wt) represents the diameter relative to which x % by weight of the particles have diameters less than dx(wt). This means that, for example, the d20(wt) value is the particle size at which 20 wt.-% of all particles are smaller than that particle size. The d50(wt) value is thus the weight median particle size, i.e. 50 wt.-% of all particles are smaller than that particle size. The measurement is made with a Sedigraph™ 5120 of Micromeritics Instrument Corporation, USA. The method and the instrument are known to the skilled person and are commonly used to determine particle size distributions. The measurement is carried out in an aqueous solution of 0.1 wt. % Na4P2O7. The samples are dispersed using a high speed stirrer and sonication.

Throughout the present document, the “specific surface area” (in m2/g) of surface-reacted calcium carbonate or other materials is determined using the BET method (using nitrogen as adsorbing gas), which is well known to the skilled man (ISO 9277:2010).

For the purpose of the present invention the “porosity” or “pore volume” refers to the intra-particle intruded specific pore volume. Said porosity or pore volume is measured using a Micromeritics Autopore V 9620 mercury porosimeter.

A “suspension” or “slurry” in the meaning of the present invention comprises insoluble solids and a liquid medium, for example water, and optionally further additives, and usually contains large amounts of solids and, thus, is more viscous and can be of higher density than the liquid from which it is formed.

The term “solid” according to the present invention refers to a material that is solid under standard ambient temperature and pressure (SATP) which refers to a temperature of 298.15 K (25° C.) and an absolute pressure of exactly 1 bar. The solid may be in the form of a powder, tablet, granules, flakes etc. Accordingly, the term “liquid medium” refers to a material that is liquid under standard ambient temperature and pressure (SATP) which refers to a temperature of 298.15 K (25° C.) and an absolute pressure of exactly 1 bar.

Where the term “comprising” is used in the present description and claims, it does not exclude other non-specified elements of major or minor functional importance. For the purposes of the present invention, the term “consisting of” is considered to be a preferred embodiment of the term “comprising”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

Terms like “obtainable” or “definable” and “obtained” or “defined” are used interchangeably. This, e.g., means that, unless the context clearly dictates otherwise, the term “obtained” does not mean to indicate that, e.g., an embodiment must be obtained by, e.g. the sequence of steps following the term “obtained” even though such a limited understanding is always included by the terms “obtained” or “defined” as a preferred embodiment.

Advantageous embodiments of the inventive catalytic system, the corresponding method of manufacturing said catalytic system and uses of said catalytic system are defined hereinafter as well as in the corresponding subclaims.

In one embodiment according to the present invention, the natural ground calcium carbonate is selected from the group consisting of marble, chalk, limestone, and mixtures thereof, or the precipitated calcium carbonate is selected from the group consisting of precipitated calcium carbonates having an aragonitic, vateritic or calcitic crystal form, and mixtures thereof.

In another embodiment according to the present invention, the at least one H3+ ion donor is selected from the group consisting of hydrochloric acid, sulphuric acid, sulphurous acid, phosphoric acid, citric acid, oxalic acid, an acidic salt, acetic acid, formic acid, and mixtures thereof, preferably the at least one H3O+ ion donor is selected from the group consisting of hydrochloric acid, sulphuric acid, sulphurous acid, phosphoric acid, oxalic acid, H2PO4−, being at least partially neutralised by a cation selected from Li+, Na+and/or K+, HPO42−, being at least partially neutralised by a cation selected from Li+, Na+, K+, Mg2+, and/or Ca2+, and mixtures thereof, more preferably the at least one H3O+ ion donor is selected from the group consisting of hydrochloric acid, sulphuric acid, sulphurous acid, phosphoric acid, oxalic acid, or mixtures thereof, and most preferably, the at least one H3O+ ion donor is phosphoric acid.

According to still another embodiment of the present invention, the solid carrier has:
(i) a volume median particle size d₅₀ from 0.1 to 75 μm, preferably from 0.5 to 50 μm, more preferably from 1 to 40 μm, even more preferably from 1.2 to 30 μm, and most preferably from 1.5 to 15 μm, and/or
(ii) a volume top cut particle size d₉₈ from 0.2 to 150 μm, preferably from 1 to 100 μm, more preferably from 2 to 80 μm, even more preferably from 2.4 to 60 μm, and most preferably from 3 to 30 μm, and/or
(iii) a specific surface area of from 10 m²/g to 200 m²/g, preferably from 20 m²/g to 180 m²/g, more preferably from 25 m²/g to 140 m²/g, even more preferably from 27 m²/g to 120 m²/g, and most preferably from 30 m²/g to 100 m²/g, measured using nitrogen and the BET method.

According to a further embodiment of the present invention, the transition metal compound is preferably selected from the group consisting of elemental Ni, elemental Ru, elemental Au, elemental Fe, elemental Cu and mixtures thereof and most preferably is selected from the group consisting of elemental Ni, elemental Ru, elemental Au and mixtures thereof.

According to a further embodiment of the present invention, the content of the transition metal element on the surface of the solid carrier is in the range of from 0.25 to 25 wt. %, preferably from 0.5 to 20 wt. %, more preferably 1 to 15 wt. %, even more preferably from 2 to 10 wt. % and most preferably from 2.5 to 5 wt. %, based on the dry weight of the solid carrier.

According to another embodiment of the present invention the calcination step (d) in the inventive method is performed
(i) under air, N₂ atmosphere, Ar atmosphere, O₂ atmosphere or mixtures thereof and/or
(ii) at a temperature between 275° C. and 475° C., preferably at a temperature between 300° C. and 450° C., and most preferably at a temperature between 350° C. and 400° C.

According to another embodiment of the present invention, the method further comprises step (f) of providing a solvent and contacting the at least one solid carrier provided in step (a) and/or the transition metal reagent provided in step (b) before or during step (c) in any order and preferably the solvent is a non-polar solvent, a polar solvent or a mixture thereof, preferably the non-polar solvent is selected from the group consisting of pentane, cyclopentane, hexane, cyclohexane, benzene, toluene, 1,4-dioxane, chloroform, diethyl ether, dichloromethane and mixtures thereof and/or the polar solvent is selected from the group consisting of tetrahydrofuran, ethyl acetate, acetone, dimethylformamide, acetonitrile, dimethyl sulphoxide, nitromethane, propylene carbonate, formic acid, n-butanol, isopropanol, n-propanol, ethanol, methanol, acetic acid, water and mixtures thereof even more preferably the solvent is a polar solvent and most preferably the solvent is water.

According to still another embodiment of the present invention, the method further comprises step (g) of removing at least part of the solvent after step (c) and before step (d) by evaporation and/or filtration and/or centrifugation and/or spray drying to obtain a concentrated mixture.

According to another embodiment of the present invention, the method further comprises step (h) of thermally treating the mixture of step (c) or the concentrated mixture of step (g) at a temperature between 25° C. and 200° C., preferably at a temperature between 50° C. and 180° C., and most preferably at a temperature between 100° C. to 150° C.

According to still another embodiment of the present invention, the transition metal reagent in the inventive method is selected from the group consisting of (NH4)2Ni(SO4)2, Ni(OCOCH3)2, NiBr2, NiCl2, NiF2, Ni(OH)2, NiI2, Ni(NO3)2, Ni(ClO4)2, Ni(SO3NH2)2, NiSO4, K2Ni(H2IO6)2, K2Ni(CN)4, [Ru(NH3)6]Cl2, [Ru(NH3)6]Cl3, [Ru(NH3)5Cl]Cl2, RuCl3, Ru(NO)(NO3) , RuI3, RuF5, HAuCl4, AuBr3, AuCl, AuCl3, Au(OH)3, AuI, KAuCl4, Pd(NO3)2, Pd(acac)2, Na2PdCl4, Pd(OAc)2, Pd(PPh3)4, PdCl2(PPh3)2, (dppf)PdCl2, (dppe)PdCl2, (dppp)PdCl2, (dppb)PdCl2, PdCl2, (C3H5PdCl)2, bis(acetate)triphenylphosphine-palladium(II), Pd(dba)2, Pd(H2NCH2CH2NH2)Cl2, Na2PtCl6 Pt(acac)2, Na2PtCl4, H2PtCl6, (NH4)2[PtCl6], PtO2·H2O, PtCl4, Pt(NO3)4, Cu2S, copper(I)-thiophene-2-carboxylate, CuBr, CuCN, CuCl, CuF, Cul, CuH, CuSCN, CuBr2, CuCO3, CuCl2, CuF2, Cu(NO3)2, Cu3(PO4)2, Cu(OH)2, CuI2, CuS, CuSO4, Cu2(OAc)4, (NH4)2Fe(SO4)2, FeBr2, FeBr3, FeCl2, FeCl3, FeF2, FeF3, FeI2, Fe(NO3)3, FeC2O4, Fe2(C2O4)3, Fe(ClO4)2, FePO4, FeSO4, Fe(BF4)2, K4Fe(CN)6 and mixtures thereof, and preferably is selected from(NH4)2Ni(SO4)2, Ni(OCOCH3)2, NiBr2, NiCl2, NiF2, Ni(OH)2, NiI2, Ni(NO3)2, Ni(ClO4)2, Ni(SO3NH2)2, NiSO4, K2Ni(H2IO6)2, K2Ni(CN)4, [Ru(NH3)6]Cl2, [Ru(NH3)6]Cl3, [Ru(NH3)5Cl]Cl2, RuCl3, Ru(NO)(NO3), RuI3, RuF5, HAuCl4, AuBr3, AuCl, AuCl3, Au(OH)3, AuI, KAuCl4, Fe(NO3)3, Cu(NO3)2, Pd(NO3)2, and Pt(NO3)4 and most preferably is selected from Ni(NO3)2, RuNO(NO3), HAuCl4, Fe(NO3)3, Cu(NO3)2, Pd(NO3)2, and Pt(NO3)4.

According to another embodiment of the present invention, the process for using the inventive catalytic system further comprises step (D) of recovering and optionally recycling the catalytic system following the chemical reaction of step (C).

### Method for Manufacturing the Catalytic System

As set out hereinabove, the method for manufacturing the inventive catalytic system comprising a transition metal compound on a solid carrier comprises steps (a)-(e). Said process optionally further comprises steps (f) and/or (g) and/or (h).

It should be understood, that the method of the present invention may be carried out as a continuous process or as a batch process. Preferably, the inventive method is carried out as a batch process.

In the following, it is referred to further details of the present invention and especially to the foregoing steps of the inventive process for locating the transition metal on the surface of a surface-reacted calcium carbonate.

It should be known that the defined embodiments of the inventive method also apply to the inventive catalytic system, as well as to the use of the inventive catalytic system, to the use of a solid carrier loaded with a transition metal as a catalyst and to the inventive products in different shapes such as granules, mouldings or extrudates and vice versa.

### Step (a): Providing at Least One Solid Carrier

According to the present invention in step (a) at least one solid carrier is provided, wherein the solid carrier is a surface-reacted calcium carbonate, wherein the surface-reacted calcium carbonate is a reaction product of ground natural calcium carbonate (GNCC) or precipitated calcium carbonate (PCC) with carbon dioxide and one or more H3O+ ion donors, wherein the carbon dioxide is formed in situ by the H3O+ ion donors treatment and/or is supplied from an external source.

The surface-reacted calcium carbonate (SRCC) is also referred to as modified calcium carbonate (MCC).

It is appreciated that the surface-reacted calcium carbonate can be one or a mixture of different kinds of surface-reacted calcium carbonate(s). In one embodiment of the present invention, the surface-reacted calcium carbonate comprises, preferably consists of, one kind of surface-reacted calcium carbonate. Alternatively, the surface-reacted calcium carbonate comprises, preferably consists of, two or more kinds of surface-reacted calcium carbonates. For example, the surface-reacted calcium carbonate comprises, preferably consists of, two or three kinds of surface-reacted calcium carbonates. Preferably, the surface-reacted calcium carbonate comprises, more preferably consists of, one kind of surface-reacted calcium carbonate.

The surface-reacted calcium carbonate is a reaction product of ground natural calcium carbonate (GNCC) or precipitated calcium carbonate (PCC) treated with carbon dioxide and one or more H3O+ ion donors, wherein the carbon dioxide is formed in situ by the H3O+ ion donors treatment and/or is supplied from an external source. Because of the reaction of ground natural calcium carbonate or precipitated calcium carbonate with carbon dioxide and the one or more H3O+ ion donors, surface-reacted calcium carbonate may comprise GNCC or PCC and at least one water-insoluble calcium salt other than calcium carbonate.

In a preferred embodiment, said surface-reacted calcium carbonate comprises GNCC or PCC and at least one water-insoluble calcium salt other than calcium carbonate which is present on at least part of the surface of said GNCC or PCC.

An H3O+ ion donor in the context of the present invention is a BrØnsted acid and/or an acid salt.

In a preferred embodiment of the invention, the surface-reacted calcium carbonate is obtained by a process comprising the steps of:
(a) providing a suspension of ground natural calcium carbonate (GNCC) or precipitated calcium carbonate (PCC);
(b) adding at least one acid having a pKₐ value of 0 or less at 20° C., or having a pKₐ value from 0 to 2.5 at 20° C. to the suspension provided in step (a); and
(c) treating the suspension provided in step (a) with carbon dioxide before, during or after step (b).

According to another embodiment, the surface-reacted calcium carbonate is obtained by a process comprising the steps of:
(a) providing a ground natural calcium carbonate (GNCC) or precipitated calcium carbonate (PCC);
(b) providing at least one water-soluble acid;
(c) providing gaseous carbon dioxide; and
(d) contacting said GNCC or PCC provided in step (a), the at least one acid provided in step (b) and the gaseous carbon dioxide provided in step (c);
   characterized in that
(i) the at least one acid provided in step (b) has a pKₐ of greater than 2.5 and less than or equal to 7 at 20° C., associated with the ionisation of its first available hydrogen, and a corresponding anion is formed on loss of this first available hydrogen capable of forming a water-soluble calcium salt; and
(ii) following contacting the at least one water-soluble acid provided in step (b) and the GNCC or PCC provided in step (a), at least one water-soluble salt, which in the case of a hydrogen-containing salt has a pKₐ of greater than 7 at 20° C., associated with the ionisation of the first available hydrogen, and the salt anion of which is capable of forming water-insoluble calcium salts, is additionally provided.

The source of calcium carbonate, e.g., ground natural calcium carbonate (GNCC), preferably is selected from calcium carbonate-containing minerals selected from the group consisting of marble, chalk, limestone and mixtures thereof. Natural calcium carbonate may comprise further naturally occurring components such as magnesium carbonate, alumino silicate etc. According to one embodiment, natural calcium carbonate, such as GNCC, comprises aragonitic, vateritic or calcitic mineralogical crystal forms of calcium carbonate or mixtures thereof.

In general, the grinding of ground natural calcium carbonate may be performed in a dry or wet grinding process and may be carried out with any conventional grinding device, for example, under conditions such that comminution predominantly results from impacts with a secondary body, i.e. in one or more of: a ball mill, a rod mill, a vibrating mill, a roll crusher, a centrifugal impact mill, a vertical bead mill, an attrition mill, a pin mill, a hammer mill, a pulverizer, a shredder, a de-clumper, a knife cutter, or other such equipment known to the skilled person. In case the ground natural calcium carbonate comprises wet ground calcium carbonate, the grinding step may be performed under conditions such that autogenous grinding takes place and/or by horizontal ball milling, and/or other such processes known to the skilled person. The wet processed ground natural calcium carbonate thus obtained may be washed and dewatered by well-known processes, e.g., by flocculation, filtration or forced evaporation prior to drying. The subsequent step of drying (if necessary) may be carried out in a single step such as spray drying, or in at least two steps. It is also common that such a mineral material undergoes a beneficiation step (such as a flotation, bleaching or magnetic separation step) to remove impurities.

As already indicated hereinabove, a precipitated calcium carbonate (PCC) in the meaning of the present invention is a synthesized material, generally obtained by precipitation following a reaction of carbon dioxide and calcium hydroxide in an aqueous environment or by precipitation of calcium and carbonate ions, for example CaCl2 and Na2CO3, out of solution. Further possible ways of producing PCC are the lime soda process, or the Solvay process in which PCC is a by-product of ammonia production. Precipitated calcium carbonate exists in three primary crystalline forms: calcite, aragonite and vaterite, and there are many different polymorphs (crystal habits) for each of these crystalline forms. Calcite has a trigonal structure with typical crystal habits such as scalenohedral (S-PCC), rhombohedral (R-PCC), hexagonal prismatic, pinacoidal, colloidal (C-PCC), cubic, and prismatic (P-PCC). Aragonite is an orthorhombic structure with typical crystal habits of twinned hexagonal prismatic crystals, as well as a diverse assortment of thin elongated prismatic, curved bladed, steep pyramidal, chisel shaped crystals, branching tree, and coral or worm-like form. Vaterite belongs to the hexagonal crystal system. The obtained aqueous PCC slurry can be mechanically dewatered and dried.

According to one embodiment of the present invention, the precipitated calcium carbonate comprises aragonitic, vateritic or calcitic mineralogical crystal forms of calcium carbonate or mixtures thereof.

Precipitated calcium carbonate may be ground prior to the treatment with carbon dioxide and at least one H3O+ ion donor by the same means as used for grinding natural calcium carbonate and described above.

According to one embodiment of the present invention, the natural or precipitated calcium carbonate is in form of particles having a weight median particle size d50(wt) of from 0.1 to 75.0 μm, preferably from 0.5 to 50.0 μm, more preferably from 1 to 30.0 μm, even more preferably from 1.2 to 30 μm and most preferably from 1.5 to 15 μm. According to a further embodiment of the present invention, the natural or precipitated calcium carbonate is in form of particles having a top cut particle size d98(wt) of from 0.2 to 150 μm, preferably from 1 to 100 μm, more preferably from 2 to 80 μm, even more preferably from 2.4 to 60 μm, and most preferably from 3 to 30 μm.

The natural or precipitated calcium carbonate may be used dry or suspended in water. Preferably, a corresponding aqueous slurry has a content of natural or precipitated calcium carbonate within the range of from 1 to 90 wt. %, more preferably from 3 to 60 wt. %, even more preferably from 5 to 40 wt. %, and most preferably from 10 to 25 wt. %, based on the total weight of said slurry.

The one or more H3O+ ion donor used for the preparation of surface-reacted calcium carbonate may be any strong acid, medium-strong acid, or weak acid, or mixtures thereof, generating H3O+ ions under the preparation conditions. According to the present invention, the at least one H3O+ ion donor can also be an acid salt, generating H3O+ ions under the preparation conditions.

According to one embodiment, the at least one H3O+ ion donor is a strong acid having a pKa of 0 or less at 20° C.

According to another embodiment, the at least one H3O+ ion donor is a medium-strong acid having a pKa value from 0 to 2.5 at 20° C. If the pKa at 20° C. is 0 or less, the acid is preferably selected from sulphuric acid, hydrochloric acid, or mixtures thereof. If the pKa at 20° C. is from 0 to 2.5, the H3O+ ion donor is preferably selected from H2SO3, H3PO4, oxalic acid, or mixtures thereof. The at least one H3O+ ion donor can also be an acid salt, for example, HSO4− or H2PO4−, being at least partially neutralized by a corresponding cation such as Li+, Na+and/or K+, or HPO42□, being at least partially neutralized by a corresponding cation such as Li+, Na+, K+, Mg2+and/or Ca2+. The at least one H3O+ ion donor can also be a mixture of one or more acids and one or more acid salts.

According to still another embodiment, the at least one H3O+ ion donor is a weak acid having a pKa value of greater than 2.5 and less than or equal to 7, when measured at 20° C., associated with the ionisation of the first available hydrogen, and having a corresponding anion, which is capable of forming water-soluble calcium salts. Subsequently, at least one water-soluble salt, which in the case of a hydrogen-containing salt has a pKa of greater than 7, when measured at 20° C., associated with the ionisation of the first available hydrogen, and the salt anion of which is capable of forming water-insoluble calcium salts, is additionally provided. According to a more preferred embodiment, the weak acid has a pKa value from greater than 2.5 to 5 at 20° C., and more preferably the weak acid is selected from the group consisting of acetic acid, formic acid, propanoic acid and mixtures thereof. Exemplary cations of said water-soluble salt are selected from the group consisting of potassium, sodium, lithium and mixtures thereof. In a more preferred embodiment, said cation is sodium or potassium. Exemplary anions of said water-soluble salt are selected from the group consisting of phosphate, dihydrogen phosphate, monohydrogen phosphate, oxalate, silicate, mixtures thereof and hydrates thereof. In a more preferred embodiment, said anion is selected from the group consisting of phosphate, dihydrogen phosphate, monohydrogen phosphate, mixtures thereof and hydrates thereof. In a most preferred embodiment, said anion is selected from the group consisting of dihydrogen phosphate, monohydrogen phosphate, mixtures thereof and hydrates thereof. Water-soluble salt addition may be performed dropwise or in one step. In the case of dropwise addition, this addition preferably takes place within a time period of 10 min. It is more preferred to add said salt in one step.

According to one embodiment of the present invention, the at least one H3O+ ion donor is selected from the group consisting of hydrochloric acid, sulphuric acid, sulphurous acid, phosphoric acid, citric acid, oxalic acid, acetic acid, an acidic salt, formic acid and mixtures thereof. Preferably the at least one H3O+ ion donor is selected from the group consisting of hydrochloric acid, sulphuric acid, sulphurous acid, phosphoric acid, oxalic acid, H2PO4−, being at least partially neutralized by a corresponding cation such as Li+, Na+and/or K+, HPO42−, being at least partially neutralized by a corresponding cation such as Li+, Na+, K+, Mg2+ and/or Ca2+ and mixtures thereof, more preferably the at least one acid is selected from the group consisting of hydrochloric acid, sulphuric acid, sulphurous acid, phosphoric acid, oxalic acid, or mixtures thereof. A particularly preferred H3O+ ion donor is phosphoric acid.

The one or more H3O+ ion donor can be added to the suspension as a concentrated solution or a more diluted solution. Preferably, the molar ratio of the H3O+ ion donor to the natural or precipitated calcium carbonate is from 0.01:1 to 4:1, more preferably from 0.02:1 to 2:1, even more preferably from 0.05:1 to 1:1 and most preferably from 0.1:1 to 0.58:1.

In another preferred embodiment, the at least one H3O+ ion donor is selected from the group consisting of hydrochloric acid, sulphuric acid, sulphurous acid, phosphoric acid, citric acid, oxalic acid, acetic acid, formic acid and mixtures thereof, wherein the molar ratio of the H3O+ ion donor to the natural or precipitated calcium carbonate is from 0.01:1 to 4:1, more preferably from 0.02:1 to 2:1, even more preferably from 0.05:1 to 1:1 and most preferably from 0.1:1 to 0.58:1.

In a particularly preferred embodiment, the at least one H3O+ ion donor is a mixture of phosphoric acid and citric acid, more preferably the molar ratio of the H3O+ ion donor to the natural or precipitated calcium carbonate is from 0.01:1 to 4:1, more preferably from 0.02:1 to 2:1, even more preferably from 0.05:1 to 1:1 and most preferably from 0.1:1 to 0.58:1. In this embodiment, phosphoric acid is preferably used in excess relative to citric acid.

As an alternative, it is also possible to add the H3O+ ion donor to the water before the natural or precipitated calcium carbonate is suspended.

In a next step, the natural or precipitated calcium carbonate is treated with carbon dioxide. If a strong acid such as sulphuric acid or hydrochloric acid is used for the H3O+ ion donor treatment of the natural or precipitated calcium carbonate, the carbon dioxide is automatically formed. Alternatively or additionally, the carbon dioxide can be supplied from an external source.

H3O+ ion donor treatment and treatment with carbon dioxide can be carried out simultaneously which is the case when a strong or medium-strong acid is used. It is also possible to carry out H3O+ ion donor treatment first, e.g., with a medium strong acid having a pKa in the range of 0 to 2.5 at 20° C., wherein carbon dioxide is formed in situ, and thus, the carbon dioxide treatment will automatically be carried out simultaneously with the H3O+ ion donor treatment, followed by the additional treatment with carbon dioxide supplied from an external source.

In a preferred embodiment, the H3O+ ion donor treatment step and/or the carbon dioxide treatment step are repeated at least once, more preferably several times. According to one embodiment, the at least one H3O+ ion donor is added over a time period of at least about 5 min, preferably at least about 10 min, typically from about 10 to about 20 min, more preferably about 30 min, even more preferably about 45 min, and sometimes about 1 h or more.

Subsequent to the H3O+ ion donor treatment and carbon dioxide treatment, the pH of the aqueous suspension, measured at 20° C., naturally reaches a value of greater than 6.0, preferably greater than 6.5, more preferably greater than 7.0, even more preferably greater than 7.5, thereby preparing the surface-reacted natural or precipitated calcium carbonate as an aqueous suspension having a pH of greater than 6.0, preferably greater than 6.5, more preferably greater than 7.0, even more preferably greater than 7.5.

Further details about the preparation of the surface-reacted natural calcium carbonate are disclosed in WO 00/39222 A1, WO 2004/083316 A1, WO 2005/121257 A2, WO 2009/074492 A1, EP 2 264 108 A1, EP 2 264 109 A1 and US 2004/0020410 A1, the content of these references herewith being included in the present document.

Similarly, surface-reacted precipitated calcium carbonate may be obtained. As can be taken in detail from WO 2009/074492 A1, surface-reacted precipitated calcium carbonate is obtained by contacting precipitated calcium carbonate with H3O+ ions and with anions being solubilized in an aqueous medium and being capable of forming water-insoluble calcium salts, in an aqueous medium to form a slurry of surface-reacted precipitated calcium carbonate, wherein said surface-reacted precipitated calcium carbonate comprises an insoluble, at least partially crystalline calcium salt of said anion formed on the surface of at least part of the precipitated calcium carbonate.

Said solubilized calcium ions correspond to an excess of solubilized calcium ions relative to the solubilized calcium ions naturally generated on dissolution of precipitated calcium carbonate by H3O+ ions, where said H3O+ ions are provided solely in the form of a counter ion to the anion, i.e. via the addition of the anion in the form of an acid or non-calcium acid salt, and in absence of any further calcium ion or calcium ion generating source.

Said excess solubilized calcium ions are preferably provided by the addition of a soluble neutral or acid calcium salt, or by the addition of an acid or a neutral or acid non-calcium salt which generates a soluble neutral or acid calcium salt in situ.

Said H3O+ ions may be provided by the addition of an acid or an acid salt of said anion, or the addition of an acid or an acid salt which simultaneously serves to provide all or part of said excess solubilized calcium ions.

In a further preferred embodiment of the preparation of the surface-reacted natural or precipitated calcium carbonate, the natural or precipitated calcium carbonate is reacted with the acid and/or the carbon dioxide in the presence of at least one compound selected from the group consisting of silicate, silica, aluminium hydroxide, earth alkali aluminate such as sodium or potassium aluminate, magnesium oxide, aluminium sulphate or mixtures thereof. Preferably, the at least one silicate is selected from an aluminium silicate, a calcium silicate, or an earth alkali metal silicate.

In another preferred embodiment, said at least one compound is aluminium sulphate hexadecahydrate. In a particularly preferred embodiment, said at least one compound is aluminium sulphate hexadecahydrate, wherein the at least one H3O+ ion donor is selected from the group consisting of hydrochloric acid, sulphuric acid, sulphurous acid, phosphoric acid, citric acid, oxalic acid, acetic acid, formic acid and mixtures thereof, more preferably the molar ratio of said H3O+ ion donor to the natural or precipitated calcium carbonate is from 0.01:1 to 4:1, more preferably from 0.02:1 to 2:1, even more preferably from 0.05:1 to 1:1 and most preferably from 0.1:1 to 0.58:1.

The foregoing components can be added to an aqueous suspension comprising the natural or precipitated calcium carbonate before adding the acid and/or carbon dioxide.

Alternatively, the foregoing components can be added to the aqueous suspension of natural or precipitated calcium carbonate while the reaction of natural or precipitated calcium carbonate with an acid and carbon dioxide has already started. Further details about the preparation of the surface-reacted natural or precipitated calcium carbonate in the presence of at least one silicate and/or silica and/or aluminium hydroxide and/or earth alkali aluminate component(s) are disclosed in WO 2004/083316 A1, the content of this reference herewith being included in the present document.

The surface-reacted calcium carbonate can be kept in suspension, optionally further stabilized by a dispersant. Conventional dispersants known to the skilled person can be used. A preferred dispersant is comprised of polyacrylic acids and/or carboxymethylcelluloses.

Alternatively, the aqueous suspension described above can be dried, thereby obtaining the solid (i.e. dry or containing as little water that it is not in a fluid form) surface-reacted natural or precipitated calcium carbonate in the form of granules or a powder.

The surface-reacted calcium carbonate may have different particle shapes, such as e.g., the shape of roses, golf balls and/or brains.

In a preferred embodiment, the surface-reacted calcium carbonate has a specific surface area of from 10 to 200 m2/g, preferably from 20 to 180 m2/g, more preferably from 25 m²/g to 140 m²/g, even more preferably from 27 m²/g to 120 m²/g, and most preferably from 30 to 100 m2/g, measured using nitrogen and the BET method according to ISO 9277:2010.

Additionally or alternatively, the surface-reacted calcium carbonate particles have a volume median particle size d50(vol) of from 0.1 to 75 μm, preferably from 0.5 to 50 μm, more preferably from 1 to 40 μm, even more preferably from 1.2 to 30 μm and most preferably from 1.5 to 15 μm.

Additionally or alternatively, the surface-reacted calcium carbonate particles have a solid top cut particle size d98(vol) of from 0.2 to 150 μm, preferably from 1 to 100 μm, more preferably from 2 to 80 μm, even more preferably from 2.4 to 60 μm, and most preferably from 3 to 30 μm.

According to one embodiment of the present invention, the solid carrier has
(i) a volume median particle size d₅₀ from 0.1 to 75 μm, preferably from 0.5 to 50 μm, more preferably from 1 to 40 μm, even more preferably from 1.2 to 30 μm, and most preferably from 1.5 to 15 μm, or
(ii) a volume top cut particle size d₉₈ from 0.2 to 150 μm, preferably from 1 to 100 μm, more preferably from 2 to 80 μm, even more preferably from 2.4 to 60 μm, and most preferably from 3 to 30 μm, or
(iii) a specific surface area of from 10 m²/g to 200 m²/g, preferably from 20 m²/g to 180 m²/g, more preferably from 25 m²/g to 140 m²/g, even more preferably from 27 m2/g to 120 m²/g, and most preferably from 30 m²/g to 100 m²/g, measured using nitrogen and the BET method.

According to another embodiment of the present invention, the solid carrier has
(i) a volume median particle size d₅₀ from 0.1 to 75 μm, preferably from 0.5 to 50 μm, more preferably from 1 to 40 μm, even more preferably from 1.2 to 30 μm, and most preferably from 1.5 to 15 μm, and
(ii) a volume top cut particle size d₉₈ from 0.2 to 150 μm, preferably from 1 to 100 μm, more preferably from 2 to 80 μm, even more preferably from 2.4 to 60 μm, and most preferably from 3 to 30 μm, and
(iii) a specific surface area of from 10 m²/g to 200 m²/g, preferably from 20 m²/g to 180 m²/g, more preferably from 25 m²/g to 140 m²/g, even more preferably from 27 m2/g to 120 m²/g, and most preferably from 30 m²/g to 100 m²/g, measured using nitrogen and the BET method.

According to another embodiment, the surface-reacted calcium carbonate has an intra-particle intruded specific pore volume in the range from 0.1 to 2.3 cm3/g, more preferably from 0.2 to 2.0 cm3/g, especially preferably from 0.4 to 1.8 cm3/g and most preferably from 0.6 to 1.6 cm3/g, calculated from mercury porosimetry measurement.

The intra-particle pore size of the surface-reacted calcium carbonate preferably is in a range of from 0.004 to 1.6 μm, more preferably in a range of between 0.005 to 1.3 μm, especially preferably from 0.006 to 1.15 μm and most preferably of 0.007 to 1.0 μm, e.g., 0.004 to 0.50 μm determined by mercury porosimetry measurement.

For the purpose of step (a) of the present invention, the solid carrier may be provided either in dried form or as a suspension in a suitable liquid medium. Unless specified otherwise, the terms “dried” or “dry” refer to a material having constant weight at 200° C., whereby constant weight means a weight change of 1 mg or less over a period of 30 s per 5 g of sample.

In a preferred embodiment, the solid carrier is provided in dried form.

### Step (b): Providing at Least One Transition Metal Reagent

In step (b) of the manufacturing method according to the present invention, at least one transition metal reagent is provided.

The transition metal reagent according to the present invention comprises Ni ions, Ru ions, Au ions, Pd ions, Pt ions, Fe ions, Cu ions and mixtures thereof and is provided in such an amount that the amount of said ions is from 0.1 to 30 wt.-%, based on the dry weight of the solid carrier. It is preferred that the transition metal in the transition metal reagent shows catalytic activity and good selectivity in chemical reactions.

In principle, there exist four types of reagents, depending on how the constituent atoms are held together: molecules held together by covalent bonds, salts held together by ionic bonds, intermetallic compounds held together by metallic bonds, and certain complexes held together by coordinate covalent bonds. The transition metal reagent thus may be a molecular transition metal reagent, a transition metal salt, a metallic transition metal compound including the elemental transition metal or a transition metal complex.

According to a preferred embodiment of the present invention, the transition metal reagent is a transition metal salt or a transition metal complex.

In another preferred embodiment according to the present invention, the transition metal reagent comprises one or more of the following counter ions: hydride, oxide, hydroxide, sulphide, fluoride, chloride, bromide, iodide, carbonate, acetate, cyanide, thiocyanate, nitrate, nitrosyl nitrate, phosphate and sulphate.

In another preferred embodiment, the transition metal reagent comprises one or more of the following ligands: acetylacetonate (acac), chloride, acetate, triphenylphosphine, 1,1′ -bis(diphenylphosphino)ferrocene (dppf), 1,2-bis(diphenyl-phosphino)ethane (dppe), 1,3-bis(diphenylphosphino)propane (dppp), 1,4-bis(diphenyl-phosphino)butane (dppb), allyl, dibenzylidene acetone or dibenzalacetone (dba), and ethylenediamine.

In a preferred embodiment, the transition metal is selected from Ni, Ru, Au, Pd, Pt, Fe, Cu and mixtures thereof, preferably Ni, Ru, Au, Pd, Pt, Cu and mixtures thereof, more preferably Ni, Ru, Au, Pd, Pt, and mixtures thereof and most preferably Ni, Ru, Au, and mixtures thereof, and the transition metal reagent is a transition metal salt or a transition metal complex. In a further preferred embodiment, the foregoing transition metal salt comprises one or more of the following counter ions: hydride, oxide, hydroxide, sulphide, fluoride, chloride, bromide, iodide, carbonate, acetate, cyanide, thiocyanate, nitrate, nitrosyl nitrate phosphate and sulphate and/or the foregoing transition metal complex comprises one or more of the following ligands: acac, chloride, acetate, triphenylphosphine, dppf, dppe, dppp, dppb, allyl, dba and ethylenediamine.

According to a preferred embodiment the transition metal salt and/or the transition metal complex is water soluble and, therefore, forms a solution when dissolved in water. The “absolute water solubility” of a compound is to be understood as the maximum concentration of a compound in water where one can observe a single phase mixture at 20° C. under equilibrium conditions. The absolute water solubility is given in g compound per 100 g water. According to a preferred embodiment the transition metal salt and/or the transition metal complexes have absolute water solubilities of above 0.1 g per 100 g water, preferably of above 1 g per 100 g water and most preferably of above 5 g per 100 g water.

According to another embodiment, the transition metal reagent is selected from the group consisting of (NH4)2Ni(SO4)2, Ni(OCOCH3)2, NiBr2, NiCl2, NiF2, Ni(OH)2, NiI2, Ni(NO3)2, Ni(ClO4)2, Ni(SO3NH2)2, NiSO4, K2Ni(H2IO6)2, K2Ni(CN)4, [Ru(NH3)6]Cl2, [Ru(NH3)6]Cl3, [Ru(NH3)5Cl]Cl2, RuCl3, Ru(NO)(NO3), RuI3, RuF5, HAuCl4, AuBr3, AuCl, AuCl3, Au(OH)3, AuI, KAulC4, Pd(NO3)2, Pd(acac)2, Na2PdCl4, Pd(OAc)2, Pd(PPh3)4, PdCl2(PPh3)2, (dppf)PdCl2, (dppe)PdCl2, (dppp)PdCl2, (dppb)PdCl2, PdCl2, (C3H5PdCl)2, bis(acetate)triphenyl-phosphine-palladium(II), Pd(dba)2, Pd(H2NCH2CH2NH2)Cl2, Na2PtCl6 Pt(acac)2, Na2PtCl4, H2PtCl6, (NH4)2[PtCl6], PtO2·H2O, PtCl4, Pt(NO3)4, Cu2S, copper(I)-thiophene-2-carboxylate, CuBr, CuCN, CuCl, CuF, Cul, CuH, CuSCN, CuBr2, CuCO3, CuCl2, CuF2, Cu(NO3)2, Cu3(PO4)2, Cu(OH)2, CuI2, CuS, CuSO4, Cu2(OAc)4, (NH4)2Fe(SO4)2, FeBr2, FeBr3, FeCl2, FeCl3, FeF2, FeF3, FeI2, Fe(NO3)3, FeC2O4, Fe2(C2O4)3, Fe(ClO4)2, FePO4, FeSO4, Fe(BF4)2, K4Fe(CN)6 and mixtures thereof. Preferably, the transition metal reagent is selected from the group consisting of (NH4)2Ni(SO4)2, Ni(OCOCH3)2, NiBr2, NiCl2, NiF2, Ni(OH)2, NiI2, Ni(NO3)2, Ni(ClO4)2, Ni(SO3NH2)2, NiSO4, K2Ni(H2IO6)2, K2Ni(CN)4, [Ru(NH3)6]Cl2, [Ru(NH3)6]Cl3, [Ru(NH3)5Cl]Cl2, RuCl3, Ru(NO)(NO3) , RuI3, RuF5, HAuCl4, AuBr3, AuCl, AuCl3, Au(OH)3, AuI, KAuCl4, Pd(NO3)2, Pd(acac)2, Na2PdCl4, Pd(OAc)2, Pd(PPh3)4, PdCl2(PPh3)2, (dppf)PdCl2, (dppe)PdCl2, (dppp)PdCl2, (dppb)PdCl2, PdCl2, (C3H5PdCl)2, bis(acetate)triphenylphosphine-palladium(II), Pd(dba)2, Pd(H2NCH2CH2NH2)Cl2, Na2PtCl6 Pt(acac)2, Na2PtCl4, H2PtCl6, (NH4)2[PtCl6], PtO2·H2O, PtCl4, Pt(NO3)4, Cu2S, copper(I)-thiophene-2-carboxylate, CuBr, CuCN, CuCl, CuF, Cul, CuH, CuSCN, CuBr2, CuCO3, CuCl2, CuF2, Cu(NO3)2, Cu3(PO4)2, Cu(OH)2, CuI2, CuS, CuSO4, Cu2(OAc)4, and mixtures thereof. More preferably, the transition metal reagent is selected from the group consisting of (NH4)2Ni(SO4)2, Ni(OCOCH3)2, NiBr2, NiCl2, NiF2, Ni(OH)2, NiI2, Ni(NO3)2, Ni(ClO4)2, Ni(SO3NH2)2, NiSO4, K2Ni(H2IO6)2, K2Ni(CN)4, [Ru(NH3)6]Cl2, [Ru(NH3)6]Cl3, [Ru(NH3)5Cl]Cl2, RuCl3, Ru(NO)(NO3) , RuI3, RuF5, HAuCl4, AuBr3, AuCl, AuCl3, Au(OH)3, AuI, KAuCl4, Pd(NO3)2, Pd(acac)2, Na2PdCl4, Pd(OAc)2, Pd(PPh3)4, PdCl2(PPh3)2, (dppf)PdCl2, (dppe)PdCl2, (dppp)PdCl2, (dppb)PdCl2, PdCl2, (C3H5PdCl)2, bis(acetate)triphenylphosphine-palladium(II), Pd(dba)2, Pd(H2NCH2CH2NH2)Cl2, Na2PtCl6 Pt(acac)2, Na2PtCl4, H2PtCl6, (NH4)2[PtCl6], PtO2·H2O, PtCl4, Pt(NO3)4, Cu2S, copper(I)-thiophene-2-carboxylate. More preferably, the transition metal reagent is selected from the group consisting of (NH4)2Ni(SO4)2, Ni(OCOCH3)2, NiBr2, NiCl2, NiF2, Ni(OH)2, NiI2, Ni(NO3)2, Ni(ClO4)2, Ni(SO3NH2)2, NiSO4, K2Ni(H2IO6)2, K2Ni(CN)4, [Ru(NH3)6]Cl2, [Ru(NH3)6]Cl3, [Ru(NH3)5Cl]Cl2, RuCl3, Ru(NO)(NO3), RuI3, RuF5, HAuCl4, AuBr3, AuCl, AuCl3, Au(OH)3, AuI, KAuCl4, Fe(NO3)3, Cu(NO3)2, Pd(NO3)2 and Pt(NO3)4 and mixtures thereof. Most preferably the transition metal reagent is selected from the group consisting of Ni(NO3)2, RuNO(NO3), HAuCl4, Fe(NO3)3, Cu(NO3)2, Pd(NO3)2, Pt(NO3)4 and mixtures thereof or from the group consisting of Ni(NO3)2, RuNO(NO3), HAuCl4, Cu(NO3)2, Pd(NO3)2, Pt(NO3)4 and mixtures thereof or from the group consisting of Ni(NO3)2, RuNO(NO3), HAuCl4, Pd(NO3)2, Pt(NO3)4 and mixtures thereof.

For the purpose of step (b), the transition metal reagent may in principle be provided in any form, meaning that the transition metal compound may be provided as a neat compound or it may be provided in a liquid medium in form of a solution or suspension.

The transition metal reagent according to the present invention is provided in such an amount that the amount of said ions is from 0.1 to 30 wt.-%, based on the dry weight of the solid carrier. Alternatively, the transition metal reagent according to the present invention is provided in such an amount that the amount of said ions is from 0.25 to 25 wt. %, preferably from 0.5 to 20 wt. %, more preferably 1 to 15 wt. %, even more preferably from 2 to 10 wt. % and most preferably from 2.5 to 5 wt. %, based on the dry weight of the solid carrier.

### Optional Step (f): Providing a Solvent

According to one embodiment of the present invention, the method further comprises optional step (f) of providing a solvent and contacting the at least one solid carrier provided in step (a) and/or the transition metal reagent provided in step (b) before or during step (c) in any order.

According to one embodiment of the present invention only the at least one solid carrier provided in step (a) is contacted with the solvent. Said slurry may have a solid content within the range of from 1 to 95 wt.-%, preferably from 3 to 60 wt.-%, more preferably from 5 to 40 wt.-% and most preferably from 10 to 25 wt.-%, based on the total weight of the slurry. To the obtained slurry the at least one transition metal reagent is added in dry form.

Alternatively, the at least one transition metal reagent provided in step (b) is contacted with the solvent. Said slurry or solution may have a solids content within the range of from 0.1 to 50 wt.-%, preferably from 0.1 to 40 wt.-%, more preferably from 0.2 to 3 wt.-% and most preferably from 0.5 to 10 wt.-%, based on the total weight of the slurry or solution. To the obtained slurry or solution the at least one solid carrier is added in dry form.

The contacting of the at least one transition metal reagent provided in step (b) with a solvent in step (f) may be preferred as this may lead to a more homogenous mixture in any of the subsequent steps, for example in contacting step (c) of the inventive method for manufacturing the catalytic system. For the same reason, solutions may be preferred over suspensions. In a preferred embodiment, the transition metal reagent provided in step (b) is thus in form of a solution or suspension in step (c), preferably in form of a solution.

According to a preferred embodiment two solvents are provided. The at least one solid carrier provided in step (a) is contacted with one solvent and the at least one transition metal reagent provided in step (b) is contacted with the other solvent. Afterwards both slurries or the slurry and the solution are mixed.

The solvent for the provision of the at least one solid carrier and the solvent for the provision of the at least one transition metal reagent may be the same or may be different. According to a preferred embodiment the two solvents are the same.

According to one embodiment the solvent is a non-polar solvent, a polar solvent or a mixture thereof.

According to a preferred embodiment of the present invention, the non-polar solvent is selected from the group consisting of pentane, cyclopentane, hexane, cyclohexane, benzene, toluene, 1,4-dioxane, chloroform, diethyl ether, dichloromethane and mixtures thereof. According to another preferred embodiment of the present invention, the polar solvent is selected from the group consisting of tetrahydrofuran, ethyl acetate, acetone, dimethylformamide, acetonitrile, dimethyl sulphoxide, nitromethane, propylene carbonate, formic acid, n-butanol, isopropanol, n-propanol, ethanol, methanol, acetic acid, water and mixtures thereof.

According to another preferred embodiment of the present invention, the solvent for the solid carrier and/or the transition metal reagent is a polar solvent and most preferably is water.

### Step (c): Contacting the at Least One Solid Carrier and the Transition Metal Reagent

In step (c) of the manufacturing method according to the present invention, the at least one solid carrier provided in step (a) and the at least one transition metal reagent provided in step (b) are brought into contact to obtain a mixture comprising a solid carrier and a transition metal reagent.

Step (c) of contacting the solid carrier and the transition metal reagent serves to impregnate at least part of the accessible surface of the solid carrier with said transition metal reagent.

The contacting of the at least one solid carrier provided in step (a) and the at least one transition metal reagent provided in step (b) can be accomplished by any conventional means known to the skilled person.

According to one embodiment of the present invention, step (c) comprises the steps of providing the at least one solid carrier provided in step (a) in a first step and then adding the at least one transition metal reagent provided in step (b) in a subsequent step. According to another embodiment of the present invention, step (c) comprises the steps of first providing the at least one transition metal reagent provided in step (b) and subsequently adding the at least one solid carrier provided in step (a). According to still another embodiment, the at least one solid carrier provided in step (a) and the at least one transition metal reagent provided in step (b) are provided and contacted simultaneously.

In case the at least one solid carrier provided in step (a) is provided as a first step, it is possible to add the at least one transition metal reagent provided in step (b) in one portion or it may be added in several equal or unequal portions, i.e. in larger and smaller portions.

During contacting step (c) of the inventive process, a mixture comprising the solid carrier of step (a) and the transition metal reagent of step (b) is obtained. Said mixture may be a solid, preferably in powder form or a suspension or slurry in liquid form. Preferably the mixture is a suspension or slurry in liquid form.

In one embodiment of the method according to the present invention (i) the at least one solid carrier of step (a) is provided in a solvent in form of a suspension; and/or (ii) the at least one transition metal reagent of step (b) is provided in a solvent in form of a solution or a suspension, preferably in form of a solution.

In a preferred embodiment, the solid carrier is provided as a suspension in a solvent, wherein also the transition metal reagent is provided in a solvent in form of a solution or suspension, preferably in form of a solution.

As already described hereinabove, the solid carrier may be provided as a suspension or slurry, in which case the suspension or slurry will contain a suitable solvent. In general, said solvent may differ from the solvent described herein as a suitable solvent for the provision of the at least one transition metal reagent in form of a solution or a suspension.

However, in a preferred embodiment, the solvent for the provision of the at least one solid carrier and the solvent for the provision of the at least one transition metal reagent is the same.

The mixture obtained in step (c) may comprise any of the solvent(s) disclosed hereinabove, for example the solvent(s) may be a non-polar solvent, a polar solvent or a mixture thereof, preferably the non-polar solvent is selected from the group consisting of pentane, cyclopentane, hexane, cyclohexane, benzene, toluene, 1,4-dioxane, chloroform, diethyl ether, dichloromethane and mixtures thereof and/or the polar solvent is selected from the group consisting of tetrahydrofuran, ethyl acetate, acetone, dimethylformamide, acetonitrile, dimethyl sulphoxide, nitromethane, propylene carbonate, formic acid, n-butanol, isopropanol, n-propanol, ethanol, methanol, acetic acid, water and mixtures thereof. Preferably, the mixture obtained in step (c) further comprises water, ethanol, ethanol/water mixtures, toluene and mixtures thereof and most preferably further comprises water.

The contacting step (c) can be carried out by any means known in the art. For example, the at least one solid carrier of step (a) and the transition metal reagent of step (b) can be brought into contact by spraying and/or mixing. Suitable devices for spraying or mixing are known to the skilled person.

According to one embodiment of the present invention, step (c) may be carried out by spraying. Preferably, step (c) is carried out by mixing.

The mixing in step (c) can be accomplished by any conventional means known to the skilled person. The skilled person will adapt the mixing conditions such as the mixing speed, dividing, and temperature according to his process equipment. Additionally, the mixing may be carried out under homogenising and/or particle dividing conditions.

For example, mixing and homogenising may be performed by use of a ploughshare mixer. Ploughshare mixers function by the principle of a fluidised bed which is produced mechanically. Ploughshare blades rotate close to the inside wall of a horizontal cylindrical drum, thereby conveying the components of the mixture out of the product bed and into the open mixing space. Said fluidised bed ensures intense mixing of even large batches in a very short time. Choppers and/or dispersers are used to disperse lumps in case of a dry operating mode. Equipment that may be used in the inventive process is commercially available, for example, from Gebriider Lodige Maschinenbau GmbH, Germany or from VISCO JET Riihrsysteme GmbH, Germany.

According to another embodiment of the present invention, step (c) is carried out for at least 1 second, preferably for at least 1 minute (e.g. 10 min, 30 min or 60 min). According to a preferred embodiment step (c) is carried out for a period of time ranging from 1 second to 60 min, preferably for a period of time ranging from 15 min to 45 min. For example, mixing step (d) is carried out for 30 min ±5 min.

It is also within the confines of the present invention that suitable solvent as described in optional step (f) may be added during process step (c), for example, in case the solid carrier is provided in dry form and the transition metal reagent is provided in neat form or in case it is intended to adjust the solids content or the Brookfield viscosity of the mixture to a specific value.

According to one embodiment of the present invention, the mixture obtained in step (c) has a solids content within the range of from 1 to 90 wt.-%, preferably from 3 to 60 wt.-%, more preferably from 5 to 40 wt.-% and most preferably from 10 to 25 wt.-%, based on the total weight of said mixture.

### Optional Step (g): Removing at Least Part of the Solvent

The method according to the present invention may optionally comprise step (g) of removing at least part of the solvent after step (c) and before step (d) by evaporation and/or filtration and/or centrifugation and/or spray drying to obtain a concentrated mixture.

As already discussed hereinabove, the mixture obtained in contacting step (c) may comprise a solvent, for example if the at least one solid carrier in step (a) is provided as a suspension or slurry or if the at least one transition metal reagent in step (b) is provided in form of a solution or suspension.

Step (g) yields a concentrated mixture, which contains less solvent than the mixture obtained in contacting step (c). In principle, concentrating step (g) can be accomplished by any conventional means known to the skilled person, for example by evaporation of the liquid medium and/or by filtration and/or by centrifugation and/or by spray drying.

The method of choice in step (g) may depend on the nature of the solvent contained in the mixture of step (c). For example, it may be preferred to remove aprotic solvents (e.g. toluene) by evaporation while protic solvents (e.g. ethanol or water) may preferably be removed by filtration. In further instances, an initial filtration combined with subsequent evaporation of residual liquid medium under reduced pressure (vacuum) may be preferred.

According to one embodiment of the present invention, the inventive method further comprises step (g) of removing at least part of the solvent contained in the mixture of step (c) by evaporation. For example, evaporation of the solvent may be carried out by application of heat and/or reduced pressure using a vacuum pump.

According to another embodiment of the present invention, the inventive method further comprises step (g) of removing at least part of the solvent contained in the mixture of step (c) by filtration. For example, filtration may be carried out by means of a drum filter or a filter press or by means of nanofiltration.

According to still another embodiment of the present invention, the inventive method further comprises step (g) of removing at least part of the solvent contained in the mixture of step (c) by filtration and evaporation, preferably by filtration and subsequent evaporation.

According to still another embodiment of the present invention, the inventive method further comprises step (g) of removing at least part of the solvent contained in the mixture of step (c) by centrifugation. For example, centrifugation and decanting of the solvent may be carried out by a disc centrifuge.

According to still another embodiment of the present invention, the inventive method further comprises step (g) of removing at least part of the solvent contained in the mixture of step (c) by spray drying. For example, spray drying of the solvent may be carried out in a spray dryer.

The concentrated mixture obtained in step (g), after removing at least part of the solvent contained in the mixture of step (c), is a concentrated mixture. In a preferred embodiment, said concentrated mixture has a solids content of at least 70 wt.-%, preferably at least 80 wt.-%, more preferably at least 85 wt.-% and most preferably at least 90 wt.-%, based on the total weight of said mixture. For example, said concentrated mixture may have a solids content of 95 wt.-%, based on the total weight of said mixture.

According to still another embodiment of the inventive process, the solvent contained in the mixture of step (c) is removed in step (g) to obtain a dried mixture.

### Optional Step (h): Thermal Treatment

According to optional step (h) of the method for manufacturing the inventive catalytic system, the mixture of step (c) or the concentrated mixture of optional step (g) is thermally treated at a temperature between 25° C. and 200° C., preferably at a temperature between 50° C. and 180° C., and most preferably at a temperature between 100 and 150° C.

The term “heating” or “thermally treatment” is not limiting the process according to the present invention to a process, wherein the temperature of the mixture is adjusted actively to the defined temperature range by addition of energy through an external heat source. Said term also comprises keeping the temperature reached in an exothermic reaction, for example in contacting step (c), during a specified period of time.

The thermal treatment may be carried out for a specific period of time. In one embodiment, step (h) is thus carried out for at least 5 mins, preferably for 0.25 h to 24 h, more preferably for 1 h to 5 h and most preferably for 2 to 3 h.

In a preferred embodiment, the mixture of step (c) or the concentrated mixture of optional step (g) is thermally treated at a temperature between 25° C. and 200° C., preferably at a temperature between 50° C. and 180° C., and most preferably at a temperature between 100 and 150° C., wherein said thermal treatment is carried out for at least 5 min, preferably for 0.25 h to 24 h, more preferably for 1 h to 5 h and most preferably for 2 to 3 h.

In general, the optional thermally treatment step may take place using any suitable thermally treatment/heating equipment and can, for example, include thermal heating and/or heating at reduced pressure using equipment such as an evaporator, a flash drier, an oven, a spray drier and/or drying in a vacuum chamber. The optional thermally treatment step can be carried out at reduced pressure, ambient pressure or under increased pressure. Preferably, the optional thermally heating step is performed at ambient pressure.

### Step (d): Calcination Step

In step (d) the mixture of step (c) is calcined at a temperature between 250° C. and 500° C.

The term “calcination” according to the present invention denotes a thermal treatment at elevated temperatures leading to a partial or full thermal conversion of the transition metal reagent (partial of full calcination). During calcination the transition metal reagent comprising Ni ions, Ru ions, Au ions, Pd ions, Pt ions, Fe ions Cu ions and mixtures thereof transforms partially or fully to Ni oxide, Ru oxide, Au oxide, Pd oxide, Pd oxide, Pt oxide and combinations thereof.

According to a preferred embodiment of the present invention, the calcination step (d) is performed at a temperature between 275° C. and 475° C., preferably at a temperature between 300° C. and 450° C., and most preferably at a temperature between 350° C. and 400° C.

The calcination step of the present invention is not limited to a step, wherein the temperature of the mixture is adjusted actively to the defined temperature range by addition of energy through an external heat source. The calcination step also comprises keeping the temperature reached in that step for a specified period of time.

The calcination step may be carried out for a specific period of time. In one embodiment, step (h) is thus carried out for at least 10 min, preferably for 0.5 h to 24 h, more preferably for 1 h to 5 h and most preferably for 2.5 to 3.5 h.

The calcination step may be carried out under air, N2 atmosphere, Ar atmosphere, O₂ atmosphere or mixtures and preferably is carried out under air.

According to a preferred embodiment of the present invention, the calcination step is performed at a temperature between 250° C. and 500° C., preferably at a temperature between 275° C. and 475° C., more preferably at a temperature between 300° C. and 450° C., and most preferably at a temperature between 350° C. and 400° C., under air, N₂ atmosphere, Ar atmosphere, O₂ atmosphere or mixtures.

In general, the calcination step may take place using any suitable calcination/heating equipment and can, for example, include thermal heating and/or heating at reduced pressure using equipment such as a flash drier or an oven. Preferably, the calcination step is performed at ambient pressure.

### Step (e): Reducing the Calcined Catalytic System

The calcined catalytic system obtained from step (d) is reduced in step (e). The reduction takes place under H2 atmosphere at a temperature between 100° C. and 500° C. By such an reduction step a catalytic system comprising a transition metal compound on the solid carrier is obtained, wherein the transition metal compound is selected from the group consisting of elemental Ni, elemental Ru, elemental Au, elemental Pd, elemental Pt, elemental Fe, elemental Cu and mixtures thereof.

The term “reducing” in the meaning of the present invention refers to a chemical reaction wherein the oxidation state of the transition metal in in the transition metal reagent is changed from higher oxidation states to zero. More precisely, during reducing step (e) the transition metal reagent on the surface of the solid carrier undergoes a reaction wherein elemental Ni, elemental Ru, elemental Au, elemental Pd, elemental Pt, elemental Fe, elemental Cu and mixtures thereof are obtained on the surface of the at least one solid carrier.

The reduction step is necessary to obtain the catalytic system comprising the transition metal compound on the solid carrier, wherein the transition metal compound is selected from the group consisting of elemental Ni, elemental Ru, elemental Au, elemental Pd, elemental Pt, elemental Fe, elemental Cu and mixtures thereof. Without such a reduction step it is not possible to obtain the transition metal compound in elemental form on the surface of the solid carrier. For example, the transition metal reagent comprises the transition metal in an oxidation state of I to VIII and is reduced to an oxidation state of 0. More precisely, the transition metal reagent comprises Ni ions in oxidation states Ni(I), Ni(II), Ni(III), Ni(IV), Ru ions in oxidation states Ru(I), Ru(II), Ru(III), Ru(IV), Ru(V), Ru(VI), Ru(VII), Ru(VIII), Au ions in oxidation states Au(I), Au(II), Au(III), Au(V), Pd ions in the oxidation states Pd(II), Pd(IV), Pt in the oxidation states (I), Pt(II), Pt(III), Pt(IV), Pt(V), Pt(VI), Fe ions in the oxidation states Fe(I), Fe(II), Fe(III), Fe(IV), Fe(V), Fe(VI), Fe(VII), Cu ions in the oxidation states Cu(I), Cu(II), Cu(III), Cu(IV) and mixtures thereof and is reduced to elemental Ni having an oxidation state of Ni(0), elemental Ru having an oxidation state of Ru(0), elemental Au having an oxidation state of Au(0), elemental Pd having an oxidation state of Pd(0), elemental Pt having an oxidation state of Pt(0), elemental Fe having an oxidation state of Pt(0), elemental Cu having an oxidation state of Cu(0) and mixtures thereof.

In addition to the elemental Ni, elemental Ru, elemental Au, elemental Pd, elemental Pt, elemental Fe, elemental Cu and mixtures thereof on the surface of the at least one solid carrier also other reaction compounds may be present after the reduction step. These reaction compounds may be products that are obtained from the counter ions of the transition metal salt or the ligands of the transition metal complex with calcium carbonate.

Preferably the amount of these reaction products is lower than 100 wt.-%, based on the dry weight of the transition metal element on the surface of the at least one solid carrier, more preferably lower than 80 wt.-%, even more preferably lower than 50 wt.-%, even more preferably lower than 30 wt.-% and most preferably lower than 10 wt.-% based on the dry weight of the transition metal element on the surface of the at least one solid carrier.

According to a preferred embodiment of the present invention, the catalytic system merely consists of the at least one solid carrier and the transition metal compound on the surface of said carrier, wherein the transition metal compound is selected from the group consisting of elemental Ni, elemental Ru, elemental Au, elemental Pd, elemental Pt, elemental Fe, elemental Cu and mixtures thereof, preferably is selected from the group consisting of elemental Ni, elemental Ru, elemental Au, elemental Pd, elemental Pt, elemental Cu and mixtures thereof, and more preferably is selected from the group consisting of elemental Ni, elemental Ru, elemental Au, elemental Pd, elemental Pt, and mixtures thereof.

The reduction step (d) is performed under H2 atmosphere, which means that the H2 comprises from 5 vol.-% to 99.99 vol.-% of H2, based on the total volume of the gas, preferably from 7 vol.-% to 99.95 vol.-% of H2, even more preferably from 10 vol.-% to 99.90 vol.-% of H2 and most preferably from 15 to 99 vol.-% of H2, based on the total volume of the gas. The remaining gas up to 100 vol. -% is an inert gas such as nitrogen, argon and/or helium.

According to a preferred embodiment of the present invention, the reducing step (e) is performed at a temperature between 200° C. and 475° C., preferably at a temperature between 300° C. and 450° C., and most preferably at a temperature between 350° C. and 400° C.

The reducing step of the present invention is not limited to a step, wherein the temperature of the mixture is adjusted actively to the defined temperature range by addition of energy through an external heat source. The reducing step also comprises keeping the temperature reached in that step for a specified period of time.

The reducing step may be carried out for a specific period of time. In one embodiment, step (e) is thus carried out for at least 10 min, preferably for 0.5 h to 24 h, more preferably for 1 h to 5 h and most preferably for 2.5 to 3.5 h.

According to a preferred embodiment of the present invention, the reducing step (e) is performed at a temperature between 100 and 500° C., preferably between 200° C. and 475° C., more preferably at a temperature between 300° C. and 450° C., and most preferably at a temperature between 350° C. and 400° C. under H2 atmosphere for at least 10 min, preferably for 0.5 h to 24 h, more preferably for 1 h to 5 h and most preferably for 2.5 to 3.5 h.

The inventors surprisingly found that by the above method it is possible to provide a catalytic system wherein the transition metal compound that is selected from the group consisting of elemental Ni, elemental Ru, elemental Au, elemental Pd, elemental Pt, elemental Fe, elemental Cu and mixtures thereof is located on the solid carrier, which is a surface-reacted calcium carbonate. Furthermore, the above method is a cheap and simple production process, which provides the inventive catalytic system. Additionally, by the above method it is possible to provide a catalytic system wherein the transition metal compound is prepared directly on the surface of the solid carrier and not before the immobilization of such a transition metal compound on the surface of the solid carrier. Due to the direct preparation of the elemental Ni, elemental Ru, elemental Au, elemental Pd, elemental Pt, elemental Fe, elemental Cu and mixtures thereof on the surface of the solid carrier no further stabilizers like polymers are necessary.

As already set out above the inventive method for manufacturing the catalytic system comprising the transition metal compound on a solid carrier comprises the steps of:
(a) providing at least one solid carrier, wherein the solid carrier is a surface-reacted calcium carbonate, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source;
(b) providing at least one transition metal reagent comprising Ni ions, Ru ions, Au ions, Pd ions, Pt ions, Fe ions, Cu ions and mixtures thereof in such an amount that the amount of said ions is from 0.1 to 30 wt.-%, based on the dry weight of the solid carrier;
(c) contacting the at least one solid carrier provided in step (a) and the transition metal reagent provided in step (b) to obtain a mixture comprising a solid carrier and a transition metal reagent; and
(d) calcining the mixture of step (c) at a temperature between 250° C. and 500° C.; and
(e) reducing the calcined catalytic system obtained from step (d) under H₂ atmosphere at a temperature between 100° C. and 500° C. for obtaining a catalytic system comprising a transition metal compound on the solid carrier, wherein the transition metal compound is selected from the group consisting of elemental Ni, elemental Ru, elemental Au, elemental Pd, elemental Pt, elemental Fe, elemental Cu and mixtures thereof.

According to another embodiment of the present invention the method for manufacturing the catalytic system comprising the transition metal compound on a solid carrier comprises the steps of:
(a) providing at least one solid carrier, wherein the solid carrier is a surface-reacted calcium carbonate, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source;
(b) providing at least one transition metal reagent comprising Ni ions, Ru ions, Au ions, Pd ions, Pt ions, Fe ions, Cu ions and mixtures thereof in such an amount that the amount of said ions is from 0.1 to 30 wt.-%, based on the dry weight of the solid carrier;
(c) contacting the at least one solid carrier provided in step (a) and the transition metal reagent provided in step (b) to obtain a mixture comprising a solid carrier and a transition metal reagent; and
(d) calcining the mixture of step (c) at a temperature between 250° C. and 500° C.; and
(e) reducing the calcined catalytic system obtained from step (d) under H₂ atmosphere at a temperature between 100° C. and 500° C. for obtaining a catalytic system comprising a transition metal compound on the solid carrier, wherein the transition metal compound is selected from the group consisting of elemental Ni, elemental Ru, elemental Au, elemental Pd, elemental Pt, elemental Fe, elemental Cu and mixtures thereof; and
(f) providing a solvent and contacting the at least one solid carrier provided in step (a) and/or the transition metal reagent provided in step (b) before or during step (c) in any order.

According to another embodiment of the present invention the method for manufacturing the catalytic system comprising the transition metal compound on a solid carrier comprises the steps of:
(a) providing at least one solid carrier, wherein the solid carrier is a surface-reacted calcium carbonate, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source;
(b) providing at least one transition metal reagent comprising Ni ions, Ru ions, Au ions, Pd ions, Pt ions, Fe ions, Cu ions and mixtures thereof in such an amount that the amount of said ions is from 0.1 to 30 wt.-%, based on the dry weight of the solid carrier;
(c) contacting the at least one solid carrier provided in step (a) and the transition metal reagent provided in step (b) to obtain a mixture comprising a solid carrier and a transition metal reagent; and
(d) calcining the mixture of step (c) at a temperature between 250° C. and 500° C.; and
(e) reducing the calcined catalytic system obtained from step (d) under H₂ atmosphere at a temperature between 100° C. and 500° C. for obtaining a catalytic system comprising a transition metal compound on the solid carrier, wherein the transition metal compound is selected from the group consisting of elemental Ni, elemental Ru, elemental Au, elemental Pd, elemental Pt, elemental Fe, elemental Cu and mixtures thereof; and
(f) providing a solvent and contacting the at least one solid carrier provided in step (a) and/or the transition metal reagent provided in step (b) before or during step (c) in any order; and
(g) removing at least part of the solvent after step (c) and before step (d) by evaporation and/or filtration and/or centrifugation and/or spray drying to obtain a concentrated mixture.

According to another embodiment of the present invention the method for manufacturing the catalytic system comprising the transition metal compound on a solid carrier comprises the steps of:
(a) providing at least one solid carrier, wherein the solid carrier is a surface-reacted calcium carbonate, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source;
(b) providing at least one transition metal reagent comprising Ni ions, Ru ions, Au ions, Pd ions, Pt ions, Fe ions, Cu ions and mixtures thereof in such an amount that the amount of said ions is from 0.1 to 30 wt.-%, based on the dry weight of the solid carrier;
(c) contacting the at least one solid carrier provided in step (a) and the transition metal reagent provided in step (b) to obtain a mixture comprising a solid carrier and a transition metal reagent; and
(d) calcining the mixture of step (c) at a temperature between 250° C. and 500° C.; and
(e) reducing the calcined catalytic system obtained from step (d) under H₂ atmosphere at a temperature between 100° C. and 500° C. for obtaining a catalytic system comprising a transition metal compound on the solid carrier, wherein the transition metal compound is selected from the group consisting of elemental Ni, elemental Ru, elemental Au, elemental Pd, elemental Pt, elemental Fe, elemental Cu and mixtures thereof; and
(f) providing a solvent and contacting the at least one solid carrier provided in step (a) and/or the transition metal reagent provided in step (b) before or during step (c) in any order; and
(g) removing at least part of the solvent after step (c) and before step (d) by evaporation and/or filtration and/or centrifugation and/or spry drying to obtain a concentrated mixture and
(h) thermally treating the mixture of step (c) or the concentrated mixture of step (g) at a temperature between 25° C. and 200° C., preferably at a temperature between 50° C. and 180° C., and most preferably at a temperature between 100° C. to 150° C.

### Further Optional Method Steps

The catalytic system obtained by the inventive method is a preferably a dry product and most preferably in the form of a powder, flakes, granules, particles, or aggregates.

The obtained catalytic system may optionally be further processed during a grinding step. In general, the grinding of the catalytic system may be performed in a dry or wet grinding process and may be carried out with any conventional grinding device, for example, under conditions such that comminution predominantly results from impacts with a secondary body, i.e. in one or more of: a ball mill, a rod mill, a vibrating mill, a roll crusher, a centrifugal impact mill, a vertical bead mill, an attrition mill, a pin mill, a hammer mill, a pulverizer, a shredder, a de-clumper, a knife cutter, or other such equipment known to the skilled person.

In case the grinding is performed as a wet grinding process, the ground catalytic system may be dried afterwards. In general, the drying may take place using any suitable drying equipment and can, for example, include thermal heating and/or heating at reduced pressure using equipment such as an evaporator, a flash drier, an oven, a spray drier and/or drying in a vacuum chamber. The drying can be carried out at reduced pressure, ambient pressure or under increased pressure. Preferably, the drying is performed at ambient pressure.

### The Catalytic System

By the inventive method an inventive catalytic system is obtained. The catalytic system according to the present invention comprises a transition metal compound on a solid carrier, wherein
a) the solid carrier is a surface-reacted calcium carbonate, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source; and
b) wherein the transition metal compound is selected from the group consisting of elemental Ni, elemental Ru, elemental Au, elemental Pd, elemental Pt, elemental Fe, elemental Cu and mixtures thereof;
and wherein the content of the transition metal element on the surface of the solid carrier is from 0.1 to 30 wt.-%, based on the dry weight of the solid carrier.

In general, the inventive catalytic system is composed of a particulate solid carrier material (surface-reacted calcium carbonate) and a transition metal compound (elemental Ni, elemental Ru, elemental Au, elemental Pd, elemental Pt, elemental Fe and/or elemental Cu) present on at least part of the accessible surface of said carrier material. The transition metal element is present in the surface of the solid carrier is from 0.1 to 30 wt.-%, based on the dry weight of the solid carrier.

Specific embodiments of the solid carrier are already described hereinabove under step (a) of the inventive method and shall apply accordingly to the solid carrier and the transition metal compound of the inventive catalytic system.

According to one embodiment, the natural ground calcium carbonate is selected from the group consisting of marble, chalk, limestone, and mixtures thereof, or the precipitated calcium carbonate is selected from the group consisting of precipitated calcium carbonates having an aragonitic, vateritic or calcitic crystal form, and mixtures thereof.

According to another embodiment of the present invention, the at least one H3O+ ion donor is selected from the group consisting of hydrochloric acid, sulphuric acid, sulphurous acid, phosphoric acid, citric acid, oxalic acid, an acidic salt, acetic acid, formic acid, and mixtures thereof, preferably the at least one H3O+ ion donor is selected from the group consisting of hydrochloric acid, sulphuric acid, sulphurous acid, phosphoric acid, oxalic acid, H2PO4−,being at least partially neutralised by a cation selected from Li+, Na+and/or K+, HPO42−, being at least partially neutralised by a cation selected from Li+, Na+, K+, Mg2+, and/or Ca2+, and mixtures thereof, more preferably the at least one H3O+ ion donor is selected from the group consisting of hydrochloric acid, sulphuric acid, sulphurous acid, phosphoric acid, oxalic acid, or mixtures thereof, and most preferably, the at least one H3O+ ion donor is phosphoric acid.

According to another embodiment of the present invention, the solid carrier has:
(i) a volume median particle size d₅₀ from 0.1 to 75 μm, preferably from 0.5 to 50 μm, more preferably from 1 to 40 μm, even more preferably from 1.2 to 30 μm, and most preferably from 1.5 to 15 μm, or
(ii) a volume top cut particle size d₉₈ from 0.2 to 150 μm, preferably from 1 to 100 μm, more preferably from 2 to 80 μm, even more preferably from 2.4 to 60 μm, and most preferably from 3 to 30 μm, or
(iii) a specific surface area of from 10 m²/g to 200 m²/g, preferably from 20 m²/g to 180 m²/g, more preferably from 25 m²/g to 140 m²/g, even more preferably from 27 m²/g to 120 m²/g, and most preferably from 30 m²/g to 100 m²/g, measured using nitrogen and the BET method.

According to another embodiment of the present invention, the solid carrier has:
(i) a volume median particle size d₅₀ from 0.1 to 75 μm, preferably from 0.5 to 50 μm, more preferably from 1 to 40 μm, even more preferably from 1.2 to 30 μm, and most preferably from 1.5 to 15 μm, and
(ii) a volume top cut particle size d₉₈ from 0.2 to 150 μm, preferably from 1 to 100 μm, more preferably from 2 to 80 μm, even more preferably from 2.4 to 60 μm, and most preferably from 3 to 30 μm, and
(iii) a specific surface area of from 10 m²/g to 200 m²/g, preferably from 20 m²/g to 180 m²/g, more preferably from 25 m²/g to 140 m²/g, even more preferably from 27 m²/g to 120 m²/g, and most preferably from 30 m²/g to 100 m²/g, measured using nitrogen and the BET method.

Specific embodiments of the transition metal compound are already described hereinabove under step (e) of the inventive method and shall apply accordingly to the solid carrier and the transition metal compound of the inventive catalytic system.

According to one embodiment of the present invention, the transition metal compound is preferably selected from the group consisting of elemental Ni, elemental Ru, elemental Au, elemental Fe, elemental Cu and mixtures thereof, more preferably is selected from the group consisting of elemental Ni, elemental Ru, elemental Au, elemental Cu and mixtures thereof, even more preferably is selected from the group consisting of elemental Ni, elemental Ru, elemental Au and mixtures thereof, and most preferably is selected from the group consisting of elemental Ni, elemental Ru, elemental Au and mixtures thereof.

According to another embodiment of the present invention, the content of the transition metal element on the surface of the solid carrier is in the range of from 0.25 to 25 wt. %, preferably from 0.5 to 20 wt. %, more preferably 1 to 15 wt. %, even more preferably from 2 to 10 wt. % and most preferably from 2.5 to 5 wt. %, based on the dry weight of the solid carrier. The content of the transition metal element on the surface of the solid carrier refers to all the transition metal elements on the surface of the solid carrier. More precisely, in case a mixture of transition metal elements is present on the surface of the solid carrier the content refers to the mixture and not to each transition metal on its own.

According to another embodiment of the present invention the catalytic system according to the present invention is in the form of a powder, flakes, granules, particles, or aggregates and preferably in the form of particles and has:
(i) a volume median particle size d₅₀ from 0.1 to 75 μm, preferably from 0.5 to 50 μm, more preferably from 1 to 40 μm, even more preferably from 1.2 to 30 μm, and most preferably from 1.5 to 15 μm, and/or
(ii) a volume top cut particle size d₉₈ from 0.2 to 150 μm, preferably from 1 to 100 μm, more preferably from 2 to 80 μm, even more preferably from 2.4 to 60 μm, and most preferably from 3 to 30 μm, and/or
(iii) a specific surface area of from 10 m²/g to 200 m²/g, preferably from 20 m²/g to 180 m²/g, more preferably from 25 m²/g to 140 m²/g, even more preferably from 27 m²/g to 120 m²/g, and most preferably from 30 m²/g to 100 m²/g, measured using nitrogen and the BET method.

The inventors found that the catalytic system according to the present invention has several advantages. First of all, it has been found that the surface-reacted calcium carbonate according to the present invention is specifically useful as carrier material in catalysis. Especially, it has been found that in combination with the above-mentioned transition metal compound, for example, higher catalytic activities, for example higher glycerol transformation under inert atmosphere, were achieved with the catalytic systems according to the present invention. Moreover, the inventive catalytic system was easier to recover and higher yields were achieved, for example, in a second catalytic cycle compared with conventional carrier systems.

The catalytic system according to the present invention comprises a transition metal compound on a solid carrier, wherein
a) the solid carrier is a surface-reacted calcium carbonate, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source; and
b) wherein the transition metal compound is selected from the group consisting of elemental Ni, elemental Ru, elemental Au, elemental Pd, elemental Pt, elemental Fe, elemental Cu and mixtures thereof, preferably is selected from the group consisting of elemental Ru, elemental Au, elemental Pd, elemental Pt and mixtures thereof;
and wherein the content of the transition metal element on the surface of the solid carrier is about 1 wt.-%, based on the dry weight of the solid carrier.

According to another embodiment of the present invention, the catalytic system according to the present invention comprises a transition metal compound on a solid carrier, wherein
a) the solid carrier is a surface-reacted calcium carbonate, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source; and
b) wherein the transition metal compound is selected from the group consisting of elemental Ni, elemental Ru, elemental Au, elemental Pd, elemental Pt, elemental Fe, elemental Cu and mixtures thereof, preferably is selected from the group consisting of elemental Ni, elemental Cu, elemental Fe and mixtures thereof;
and wherein the content of the transition metal element on the surface of the solid carrier is about 10 wt.-%, based on the dry weight of the solid carrier.

According to another embodiment of the present invention, the catalytic system according to the present invention comprises a transition metal compound on a solid carrier, wherein
a) the solid carrier is a surface-reacted calcium carbonate, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source; and
b) wherein the transition metal compound is selected from the group consisting of elemental Ni, elemental Ru, elemental Au, elemental Pd, elemental Pt, elemental Fe, elemental Cu and mixtures thereof;
wherein the content of the transition metal element on the surface of the solid carrier is from 0.1 to 30 wt.-%, based on the dry weight of the solid carrier,
and wherein the solid carrier has
(i) a volume median particle size d₅₀ from 1.5 to 15 μm, preferably about 5.5 μm and
(ii) a volume top cut particle size d₉₈ from 3 to 30 μm, preferably about 10.5 μm and
(iii) a specific surface area of from 20 m²/g to 180 m²/g, preferably about 140 m²/g, measured using nitrogen and the BET method.

### Use of the Inventive Catalytic System in Catalysis

According to one aspect of the present invention a solid carrier as described hereinabove that is loaded with a transition metal compound as described hereinabove is used as a catalyst.

The inventive catalytic system was found to be particularly useful in a number of catalytic reactions. For example, higher yields in glycerol transformation under inert atmosphere allowed to obtain high yields of lactic acid known to be a starting materials for numerous products such as the biodegradable polylactic acid were achieved.

One aspect of the present invention therefore relates to the use of the inventive catalytic system in a process comprising the following steps:
(A) providing one or more reactants;
(B) providing the inventive catalytic system;
(C) subjecting the one or more reactants provided in step (A) to a chemical reaction under air, O₂ atmosphere, H₂ atmosphere or inert atmosphere at a temperature between 75 and 300° C. in the presence of the catalytic system provided in step (B).

For example, the inventive catalytic system may be recovered more easily and higher yields may be achieved in a second catalytic cycle compared with conventional carrier systems, a preferred embodiment of the present invention relates to the use of the inventive catalytic system in a process according to the foregoing aspect, wherein said process further comprises step (D) of recovering the catalytic system following the chemical reaction of step (C) and optionally recycling the catalytic system following the chemical reaction of step (C).

In a preferred embodiment of the present invention, the chemical reaction in step (C) comprises heterogeneous catalysis. In a more preferred embodiment, the chemical reaction in step (C) may be selected from one or more of the following reaction types: hydrogenolyses, C—C couplings and C—C cross couplings, C—N cross couplings, C—O cross couplings, C—S cross couplings, cycloaddition reactions, alkene hydrogenations and alkyne hydrogenations, allylic substitutions, reductions of nitro groups and hydrocarbonylations of aryl halides, preferably hydrogenolyses, C—C couplings and C—C cross couplings.

The inventive catalytic system may also be used in form of different shapes such as granules, mouldings or extrudates comprising said catalytic system. Typical shapes include spheres, minispheres, monoliths, honeycombs, rings etc.

Granules are made by crushing and screening gels to obtain the desired size or by drying precipitated pastes together with binders. Optionally, the granulation process further includes heat treatment to achieve specific physical properties. The particle size of granules typically ranges from 40 μm up to 1 cm.

Mouldings are hollow forms having a particular shape obtained from something in a malleable state.

Extrudates are formed by pushing a paste through a die, cutting to length, drying and optional calcining.

The scope and interest of the invention may be better understood on basis of the following examples which are intended to illustrate embodiments of the present invention.

### EXAMPLES

### 1. Measurement Methods

The following measurement methods were used to evaluate the parameters given in the examples and claims.

### BET Specific Surface Area (SSA) of a Material

The BET specific surface area was measured via the BET process according to ISO 9277:2010 using nitrogen, following conditioning of the sample by heating at 250° C. for a period of 30 minutes. Prior to such measurements, the sample was filtered, rinsed and dried at 110° C. in an oven for at least 12 hours.

Particle Size Distribution (Volume % Particles with a Diameter<X), d₅₀ Value (Volume Median Grain Diameter) and d₉₈ Value of a Particulate Material:

Volume median grain diameter d50 was evaluated using a Malvern Mastersizer 2000 Laser Diffraction System. The d50 or d98 value, measured using a Malvern Mastersizer 2000 Laser Diffraction System, indicates a diameter value such that 50% or 98% by volume, respectively, of the particles have a diameter of less than this value. The raw data obtained by the measurement are analysed using the Mie theory, with a particle refractive index of 1.57 and an absorption index of 0.005.

The weight median grain diameter is determined by the sedimentation method, which is an analysis of sedimentation behaviour in a gravimetric field. The measurement is made with a Sedigraph™ 5100, Micromeritics Instrument Corporation. The method and the instrument are known to the skilled person and are commonly used to determine grain size of fillers and pigments. The measurement is carried out in an aqueous solution of 0.1 wt % Na4P2O7. The samples were dispersed using a high speed stirrer and supersonicated.

The processes and instruments are known to the skilled person and are commonly used to determine grain size of fillers and pigments.

### Porosity/Pore Volume

The porosity or pore volume is measured using a Micromeritics Autopore IV 9500 mercury porosimeter having a maximum applied pressure of mercury 414 MPa (60 000 psi), equivalent to a Laplace throat diameter of 0.004 μm (˜nm). The equilibration time used at each pressure step is 20 seconds. The sample material is sealed in a 5 ml chamber powder penetrometer for analysis. The data are corrected for mercury compression, penetrometer expansion and sample material compression using the software Pore-Comp (Gane, P. A. C., Kettle, J. P., Matthews, G. P. and Ridgway, C. J., “Void Space Structure of Compressible Polymer Spheres and Consolidated Calcium Carbonate Paper-Coating Formulations”, Industrial and Engineering Chemistry Research, 35(5), 1996, p1753-1764.).

### X-Ray Photoelectron Spectroscopy (XPS) Measurements

The X-ray photoelectron spectroscopy (XPS) experiments were carried out in a Kratos AXIS Ultra DLD spectrometer using a monochromatic Al Kα radiation (hv=1486.6 eV) operating at 225 W (15 mA, 15 kV). Instrument base pressure was 4×10−10 Torr. The instrument work function was calibrated to give an Au 4f7/2 metallic gold binding energy (BE) of 83.96 eV. The spectrometer dispersion was adjusted to give a binding energy (BE) of 932.62 eV for metallic Cu 2p3/2. The Kratos charge neutralizer system was used for all analyses. Charge neutralization was deemed to have been fully achieved by monitoring the C is signal for adventitious carbon. For each sample, a general survey spectrum was recorded within a binding energy range from 1200 to −5 eV with a 160 eV pass energy, a 1 eV step and a 1 s dwell time. High-resolution core level spectra were obtained using an analysis area of ≈300 μm×700 μm and a 20 eV pass energy. This pass energy corresponds to Ag 3d5/2 Full Width at Half Maximum (FWHM) of 0.48 eV. Core level spectra were recorded with a 0.1 eV step and a 150 ms dwell time. The instrument detection limit is around 0.1 atomic % at the surface.

Spectra were analysed using CasaXPS software (version 2.3.16). Gaussian (70%)-Lorentzian (30%) profiles were used for each component except for metallic component for which asymmetrical Lorentzian profiles were used. For each sample, a single peak ascribed to alkyl type carbon (C—C, C—H), was fitted to the main peak of the C is spectrum for adventitious carbon. A second peak was added and was constrained to be 1.5 eV above the main peak. This higher BE peak is ascribed to alcohol (C—OH) and/or ester (C—O—C) functionality. All spectra have been charge corrected to give the adventitious C is spectral component (C—C, C—H) a BE of 284.8 eV. Quantification was performed after the subtraction of a standard Shirley background for all spectra. After a background removal for each spectrum, a relative atomic quantification of the chemical elements present at the surface can be estimated.

### 2. Material and Equipment

### Preparation of Surface-Reacted Calcium Carbonate (SRCC) Powder

(d₅₀=5.5 μm, d₉₈=10.6 μm, SSA=141.5 m²g⁻¹)

SRCC was obtained by preparing 10 litres of an aqueous suspension of ground calcium carbonate in a mixing vessel by adjusting the solids content of a wet ground marble calcium carbonate, containing polyacrylate dispersant added in the grinding process, from Omya Hustadmarmor AS having a mass based particle size distribution with 90 w/w % of the particles finer than 2 μm, as determined by sedimentation, such that a solids content of 16 wt %, based on the total weight of the aqueous suspension, is obtained.

Whilst mixing the slurry, 3 kg of an aqueous solution containing 30 wt % phosphoric acid was added to said suspension over a period of 10 minutes at a temperature of 70° C. Two minutes after the start of the phosphoric acid solution addition, 0.36 kg of an aqueous solution containing 25 wt% citric acid was added to said suspension over a period of 0.5 minutes. After the addition of the two solutions, the slurry was stirred for an additional 5 minutes, before removing it from the vessel and drying.

### Preparation of the Catalytic System

The preparation of the catalytic system was performed using ‘Chemspeed Catimpreg workstation designed for automated parallel synthesis of catalysts by coprecipitation and impregnation. In the first stage, a SRCC of 141.5 m²/g as prepared above was dried overnight at 100° C., then distributed in the different glass reactors, followed by adding water into the SRCC, agitating the components at 600 RPM for 5 minutes. The different metal precursor solutions, prepared in water solvent, were added after on the carrier, followed by an agitation process at 600 RPM for 60 minutes. The catalytic systems were next dried at 90° C. under vacuum (950 mbar) over 6 hours. A calcination step under static air was performed at 400° C. for 3 hours, followed by a reduction under a hydrogen flow at 350° C. for 3 hours. The obtained catalytic systems and the used metal salts used during the preparation procedure are described in the table below:

| | | | | | Theoretical | |
|---|---|---|---|---|---|---|
| | | | | | amount of the | |
| | | | | | elemental | |
| Name of | | Metal salt | | | metal in the | |
| the | Used | used for the | | | final catalytic | BET |
| catalyst | carrier | preparation | Producer | Reference | system (wt %) | (m²/g) |
| Fe, | SRCC | Fe(NO₃)₃ | Sigma | 216828 | 10 | 51.5 |
| 10%/SRCC | | | Aldrich | | | |
| Ni, | | Ni(NO₃)₂ | Sigma | 72253 | 10 | 61.8 |
| 10%/SRCC | | | Aldrich | | | |
| Cu, | | Cu(NO₃)₂ | Sigma | 61194 | 10 | 57.5 |
| 10%/SRCC | | | Aldrich | | | |
| Ru, | | RuNO(NO₃)₃ | Alfa Aesar | 12175 | 1 | 116.5 |
| 1%/SRCC | | | | | | |
| Pd, | | Pd(NO₃)₂ | Sigma | 380040 | 1 | — |
| 1%/SRCC | | | Aldrich | | | |
| Pt, | | Pt(NO₃)₄ | Alfa Aesar | H37737 | 1 | — |
| 1%/SRCC | | | | | | |
| Au, | | HAuCl₄ | Sigma | 520918 | 1 | 118.3 |
| 1%/SRCC | | | Aldrich | | | |

### 3. Example Data

### Characterization of the Catalytic Systems

XPS measurements of the obtained catalytic systems were performed. The relative atomic percent concentration for samples after calcination and after calcination +reduction under hydrogen flow are given in the table below:

| Sample | O | Ca | P | Cu | Fe | Ni | Pd | Pt | Au | Ru |
|---|---|---|---|---|---|---|---|---|---|---|
| Cu, 10%/SRCC calcined | 67.1 | 18.4 | 11.5 | 3.0 | — | — | — | — | — | — |
| Cu, 10%/SRCC | 66.8 | 19.9 | 11.9 | 1.5 | — | — | — | — | — | — |
| calcined + reduced | | | | | | | | | | |
| Fe, 10%/SRCC calcined | 70.2 | 16.7 | 8.6 | — | 4.5 | — | — | — | — | — |
| Fe, 10%/SRCC calcined + | 65.6 | 19.7 | 11.9 | — | 2.8 | — | — | — | — | — |
| reduced | | | | | | | | | | |
| Ni, 10%/SRCC calcined | 69.9 | 16.5 | 8.5 | — | — | 5.1 | — | — | — | — |
| Ni, 10%/SRCC | 65.7 | 19.6 | 11.9 | — | — | 2.8 | — | — | — | — |
| calcined + reduced | | | | | | | | | | |
| Pd, 1%/SRCC calcined | 72.7 | 18.5 | 8.7 | — | — | — | <0.5 | — | — | — |
| Pd, 1%/SRCC calcined + | 67.6 | 20.8 | 11.6 | — | — | — | <0.5 | — | — | — |
| reduced | | | | | | | | | | |
| Pt, 1%/SRCC calcined | 72.9 | 18.2 | 8.8 | — | — | — | — | <0.5 | — | — |
| Pt, 1%/SRCC calcined + | 67.2 | 20.5 | 12.1 | — | — | — | — | <0.5 | — | — |
| reduced | | | | | | | | | | |
| Au, 1%/SRCC calcined | 71.9 | 18.9 | 9.3 | — | — | — | — | — | <0.5 | — |
| Au, 1%/SRCC calcined + | 66.9 | 20.7 | 12.3 | — | — | — | — | — | <0.5 | — |
| reduced | | | | | | | | | | |
| Ru, 1%/SRCC calcined | 73.8 | 17.4 | 8.6 | — | — | — | — | — | — | <0.5 |
| Ru, 1%/SRCC calcined + | 69.2 | 19.6 | 11.0 | — | — | — | — | — | — | <0.5 |
| reduced | | | | | | | | | | |

An identification of the metal species and their oxidation state, on the surface of the catalytic systems is presented in the below table. These remarks are extracted from the measured XPS data and show the difference occurring on the catalytic systems after calcination and after calcination+reduction.

| Sample | Metals core level spectra |
|---|---|
| Cu, 10%/SRCC | Cu 2p spectrum presents a complex structure and is decomposed into |
| calcined | several components. The spectral envelope and decomposition is |
| | consistent with the presence of copper oxide in its +2 oxidation state. |
| Cu, 10%/SRCC | Cu 2p spectrum presents a different spectral envelope. It can be |
| calcined + | decomposed into a mixture of copper oxide in its 2+ oxidation state and a |
| reduced | reduced copper. The study of the Cu L3M4, 5M4, 5 Auger peak, and the |
| | calculation of the modified Auger parameter allows to identify the reduced |
| | species as copper oxide in its 1+ oxidation state. However, the oxidation |
| | state of +1 is obtained due to the oxidation of the elemental Cu on the |
| | surface of the solid carrier under air, occurred during the sample transfer |
| | step to the XPS device. |
| Fe, 10%/SRCC | Fe 2p spectrum presents a complex structure and is decomposed into |
| calcined | several components. The spectral envelope and decomposition is |
| | consistent with a mixture of iron oxides, with both Fe2+ and Fe3+ states. |
| Fe, 10%/SRCC | Fe 2p spectrum presents again a complex structure corresponding to a |
| calcined + | mixture of Fe2+ and Fe3+ states. However, an additional component at |
| reduced | lower BE (BE = 708.9 eV) is found and corresponds to the presence of |
| | metallic iron. |
| Ni, 10%/SRCC | Ni 2p spectrum presents a complex structure and is decomposed into |
| calcined | several components. The spectral envelope and decomposition is |
| | consistent with a mixture of nickel oxide and hydroxide. |
| Ni, 10%/SRCC | Ni 2p spectrum presents again a complex structure corresponding to a |
| calcined + | mixture of nickel oxide and hydroxide. However, an additional component |
| reduced | at lower BE (BE = 851.9 eV) is found and corresponds to the presence of |
| | metallic nickel. |
| Pd, 1%/SRCC | Pd 3d spectrum presents only one component (i.e. one doublet peak). The |
| calcined | binding energy for the main peak (corresponding to the Pd 3d5/2 orbital) is |
| | 336.6 eV. This BE is consistent with the presence of palladium oxide in its |
| | 2+ oxidation state. |
| Pd, 1%/SRCC | Pd 3d spectrum presents only one component (i.e. one doublet peak). The |
| calcined + | binding energy for the main peak (corresponding to the Pd 3d5/2 orbital) is |
| reduced | 335.0 eV. This BE is consistent with the presence of metallic palladium. |
| Pt, 1%/SRCC | Pt 4f spectrum presents two components (i.e. two doublet peaks). Both |
| calcined | doublet peaks are symmetrical. The binding energy (BE) for the main |
| | peaks (corresponding to the Pt 4f7/2 orbital) are 72.4 eV and 74.2 eV. |
| | These BE are consistent with the presence of a mixture of platinum oxides, |
| | with both platinum divalent state and platinum tetravalent state. |
| Pt, 1%/SRCC | Pt 4f spectrum presents only one component (i.e. one doublet peak). The |
| calcined + | doublet peak is asymmetrical at high binding energy. The binding energy |
| reduced | for the main peak (corresponding to the Pt 4f7/2 orbital) is 70.3 eV. This |
| | BE along with the asymmetry of the peaks is consistent with the presence |
| | of metallic platinum. |
| Au, 1%/SRCC | Due to the low amount of gold at the surface of the samples (below 0.5%) |
| calcined | as compared to the percentage of calcium, and the weak chemical shift of |
| Au, 1%/SRCC | gold in its different oxidation states, it is not possible to conclude on the |
| calcined + | oxidation state of the gold. |
| reduced | |
| Ru, 1%/SRCC | Ru 3d spectrum presents only one component (i.e. one doublet peak). The |
| calcined | binding energy for the main peak (corresponding to the Ru 3d5/2 orbital) |
| | is 280.7 eV. This BE is consistent with the presence of ruthenium oxide in |
| | its 4+ oxidation state. |
| Ru, 1%/SRCC | Ru 3d spectrum presents only one component (i.e. one doublet peak). The |
| calcined + | binding energy for the main peak (corresponding to the Ru 3d5/2 orbital) |
| reduced | is 279.9 eV eV. This BE is consistent with the presence of metallic |
| | ruthenium. |

### Catalytic Investigations

The obtained catalytic systems were evaluated in three different types of chemical transformations, using glycerol as a starting molecule. Glycerol chemical transformations were performed under hydrogen or inert atmosphere (nitrogen) or oxygen atmospheres. The procedure was performed using a Screening Pressure Reactor (SPR) from Unchained Labs, which is an automated high-throughput reactor system.

In a first step, the reactors were filled with the catalytic system, glycerol and sodium hydroxide reagents. The reactors were next purged with nitrogen while mixing its contents, to eliminate air. Then the required atmosphere was replaced, followed by heating the reactors to the desired temperatures. The performed reactivity tests are described in the table below:

| Atmosphere | Pressure (bar) | Temperature (° C.) | Time (hours) | NaOH/Gly molar ratio |
|---|---|---|---|---|
| H₂ | 30 | 200 | 6 | 1.5 |
| | | | 12 | |
| N₂ | 30 | 200 | 6 | |
| | | | 12 | |
| 40% O₂/60% N₂ | 7.5 | 80 | 4 | 4 |

For the identification of the products obtained during the catalytic reaction, HPLC-UV liquid chromatograph from Shimadzu equipped with UV detector SPD-20A (λ=210 nm), pumps LC-30AD coupled with Waytt Refractive Index (RI) detector (Optilab T-rEX) were used for the qualitative and quantitative analysis of the products. A calibration of all the potentially obtained products was performed, for a precise quantification. HPLC analysis were carried out using a LC column Bio-Rad Aminex HPX-87H, operated at 60° C. A 0.01N H2SO4 aqueous solution was used as the mobile phase. Products were analysed at a flow rate of 0.5 mL/min.

The results obtained using the different catalytic systems under a reductive

atmosphere are presented in the table below:

| Used | | | Glycerol | %ª | | | | |
|---|---|---|---|---|---|---|---|---|
| catalytic | Experimental | Glycerol/Metal | conv. | Lactic | | | | |
| system | conditions | molar ratio | (%) | acid | 1,2-Popanediol | Methanol | Ethanol | Carbon balance |
| Fe, 10%/ | 200°C., 6 hours, H₂ 30 | 106 | 4.3 | 1.8 | 0.0 | 0.0 | 0.0 | 97.5 |
| SRCC | bar, NaOH/Gly of 1.5 | | | | | | | |
| | 200° C., 12 hours, H₂ 30 | | 5.6 | 2.0 | 0.0 | 0.0 | 0.0 | 96.4 |
| | bar, NaOH/Gly of 1.5 | | | | | | | |
| Ni, 10%/ | 200° C., 6 hours, H₂ 30 | 107 | 100 | 52.6 | 7.8 | 9.3 | 4.9 | 77.9 |
| SRCC | bar, NaOH/Gly of 1.5 | | | | | | | |
| | 200° C., 12 hours, H₂ 30 | | 100 | 49.7 | 6.9 | 10.2 | 6.1 | 75.4 |
| | bar, NaOH/Gly of 1.5 | | | | | | | |
| Cu, 10%/ | 200° C., 6 hours, H₂ 30 | 105 | 37.6 | 29.1 | 3.2 | 0.0 | 0.0 | 95.4 |
| SRCC | bar, NaOH/Gly of 1.5 | | | | | | | |
| | 200° C., 12 hours, | | 55.7 | 39.5 | 6.2 | 0.0 | 0.0 | 91.1 |
| | H₂ 30 bar, NaOH/Gly of | | | | | | | |
| | 1.5 | | | | | | | |
| Ru, 1%/ | 200° C., 6 hours, H₂ 30 | 1462 | 26.2 | 22.4 | 0.0 | 0.0 | 0.0 | 96.3 |
| SRCC | bar, NaOH/Gly of 1.5 | | | | | | | |
| | 200° C., 12 hours, H₂ 30 | | 29.8 | 25.1 | 0.0 | 0.0 | 0.0 | 95.4 |
| | bar, NaOH/Gly of 1.5 | | | | | | | |
| Pd, 1%/ | 200° C., 6 hours, H₂ 30 | 1534 | 4.4 | 1.7 | 0.0 | 0.0 | 0.0 | 97.3 |
| SRCC | bar, NaOH/Gly of 1.5 | | | | | | | |
| | 200° C., 12 hours, H₂ 30 | | 5.9 | 2.1 | 0.0 | 0.0 | 0.0 | 96.1 |
| | bar, NaOH/Gly of 1.5 | | | | | | | |
| Pt, 1%/ | 200° C., 6 hours, H₂ 30 | 1539 | 61.9 | 52.5 | 0.7 | 2.7 | 0.0 | 95.1 |
| SRCC | bar, NaOH/Gly of 1.5 | | | | | | | |
| | 200° C., 12 hours, H₂ 30 | | 100 | 82.2 | 2.6 | 4.7 | 0.0 | 91.9 |
| | bar, NaOH/Gly of 1.5 | | | | | | | |
| Au, 1%/ | 200° C., 6 hours, H₂ 30 | 1555 | 5.7 | 2.5 | 0.0 | 0.0 | 0.0 | 96.8 |
| SRCC | bar, NaOH/Gly of 1.5 | | | | | | | |
| | 200° C., 12 hours, H₂ 30 | | 8.2 | 3.8 | 0.0 | 0.0 | 0.0 | 95.7 |
| | bar, NaOH/Gly of 1.5 | | | | | | | |

^{a}The remaining products up to 100% are only detected in limited amounts and, therefore, are not presented in this table.

The results obtained using the different catalytic systems under an inert

atmosphere are presented in the table below:

| Used | | | Glycerol | %ª | | | | |
|---|---|---|---|---|---|---|---|---|
| catalytic | Experimental | Glycerol/Metal | conv. | Lactic | 1,2- | | | |
| system | conditions | molar ratio | (%) | acid | Propanediol | Methanol | Ethanol | Carbon balance |
| Fe, 10%/ | 200° C., 6 hours, N₂ 30 | 106 | 6.6 | 3.9 | 0.0 | 0.0 | 0.0 | 97.4 |
| SRCC | bar, NaOH/Gly of 1.5 | | | | | | | |
| | 200° C., 12 hours, N₂ 30 | | 6.5 | 4.1 | 0.0 | 0.0 | 0.0 | 97.7 |
| | bar, NaOH/Gly of 1.5 | | | | | | | |
| Ni, 10%/ | 200° C., 6 hours, N₂ 30 | 107 | 100 | 59.9 | 2.2 | 12.5 | 5.5 | 83.1 |
| SRCC | bar, NaOH/Gly of 1.5 | | | | | | | |
| | 200° C., 12 hours, N2 30 | | 100 | 69.7 | 1.9 | 0.8 | 2.3 | 78.9 |
| | bar, NaOH/Gly of 1.5 | | | | | | | |
| Cu, 10%/ | 200° C., 6 hours, N₂ 30 | 105 | 97.6 | 72.3 | 7.0 | 3.8 | 0.0 | 88.6 |
| SRCC | bar, NaOH/Gly of 1.5 | | | | | | | |
| | 200° C., 12 hours, N₂ 30 | | 100 | 88.3 | 1.8 | 0.0 | 0.0 | 96.0 |
| | bar, NaOH/Gly of 1.5 | | | | | | | |
| Ru, 1%/ | 200° C., 6 hours, N₂ 30 | 1462 | 54.8 | 47.4 | 0.4 | 0.0 | 0.0 | 94.5 |
| SRCC | bar, NaOH/Gly of 1.5 | | | | | | | |
| | 200° C., 12 hours, N₂ 30 | | 90.6 | 86.9 | 1.0 | 0.0 | 0.6 | 101.8 |
| | bar, NaOH/Gly of 1.5 | | | | | | | |
| Pd, 1%/ | 200° C., 6 hours, N₂ 30 | 1534 | 4.6 | 2.8 | 0.0 | 0.0 | 0.0 | 98.5 |
| SRCC | bar, NaOH/Gly of 1.5 | | | | | | | |
| | 200° C., 12 hours, N₂ 30 | | 8.6 | 5.4 | 0.0 | 0.0 | 0.0 | 96.9 |
| | bar, NaOH/Gly of 1.5 | | | | | | | |
| Pt, 1 %/ | 200° C., 6 hours, N₂ 30 | 1539 | 100 | 82.4 | 0.0 | 0.0 | 0.0 | 83.7 |
| SRCC | bar, NaOH/Gly of 1.5 | | | | | | | |
| | 200° C., 12 hours, N₂ 30 | | 100 | 89.5 | 0.0 | 0.0 | 0.0 | 92.5 |
| | bar, NaOH/Gly of 1.5 | | | | | | | |
| Au, 1%/ | 200° C., 6 hours, N₂ 30 | 1555 | 10.5 | 7.7 | 0.0 | 0.0 | 0.0 | 97.6 |
| SRCC | bar, NaOH/Gly of 1.5 | | | | | | | |
| | 200° C., 12 hours, N₂ 30 | | 7.0 | 5.6 | 0.0 | 0.0 | 0.0 | 98.8 |
| | bar, NaOH/Gly of 1.5 | | | | | | | |

^{a}The remaining products up to 100% are only detected in limited amounts and, therefore, and are not presented in this table.

The results obtained using the different catalytic systems under an oxidative atmosphere are presented in the table below:

| Used | | | Glycerol | %ª | | | | | |
|---|---|---|---|---|---|---|---|---|---|
| catalytic | Experimental | Glycerol/Metal molar | conv | Glyceric | Glycolic | Lactic | Formic | | Carbon |
| system | conditions | ratio | (%) | acid | acid | acid | acid | 1,2-Propanediol | balance |
| Fe, 10%/ | 100° C., 4 hours, 40% O₂ at | 106 | 5.6 | 0.2 | 1.8 | 2.2 | 1.0 | 0.0 | 99.6 |
| SRCC | 17 bar, NaOH/Gly of 4 | | | | | | | | |
| Ni,10%/ | 100° C., 4 hours, 40% O₂ at | 107 | 4.9 | 0.1 | 1.3 | 5.6 | 0.8 | 0.0 | 103.0 |
| SRCC | 17 bar, NaOH/Gly of 4 | | | | | | | | |
| Cu, 10%/ | 100° C., 4 hours, 40% O₂ at | 105 | 5.3 | 1.1 | 1.1 | 2.1 | 0.8 | 0.0 | 100.0 |
| SRCC | 17 bar, NaOH/Gly of 4 | | | | | | | | |
| Ru, 1%/ | 100° C., 4 hours, 40% O₂ at | 1462 | 5.6 | 0.0 | 0.0 | 0.0 | 0.1 | 0.0 | 94.5 |
| SRCC | 17 bar, NaOH/Gly of 4 | | | | | | | | |
| Pd, 1%/ | 100° C., 4 hours, 40% O₂ at | 153 | 10.5 | 1.2 | 1.9 | 6.5 | 1.7 | 0.0 | 101.1 |
| SRCC | 17 bar, NaOH/Gly of 4 | | | | | | | | |
| Pt, 1%/ | 100° C., 4 hours, 40% O₂ at | 1539 | 13.0 | 1.9 | 2.2 | 7.3 | 1.8 | 0.0 | 100.7 |
| SRCC | 17 bar, NaOH/Gly of 4 | | | | | | | | |
| Au, 1%/ | 100° C., 4 hours, 40% O₂ at | 1555 | 4.2 | 0.4 | 1.4 | 2.0 | 0.9 | 0.0 | 100.8 |
| SRCC | 17 bar, NaOH/Gly of 4 | | | | | | | | |

^{a}The remaining products are only detected in limited amounts and, therefore are not presented in this table.

As can be seen from the above data by the inventive method it is possible to provide a catalytic system wherein the transition metal compound that is selected from the group consisting of elemental Ni, elemental Ru, elemental Au, elemental Pd, elemental Pt, elemental Fe, elemental Cu and mixtures thereof is located on the solid carrier, which is a surface-reacted calcium carbonate. Furthermore, the inventive method is a cheap and simple production process which provides the inventive catalytic system.

As can be seen from the above experimental data the surface-reacted calcium carbonate is useful due to its specific surface properties as carrier material for specific elemental transition metal compounds in the catalysis. Furthermore, it can be seen that with the inventive catalytic system high catalytic activities, for example high glycerol transformation under inert atmosphere, hydrogen or oxygen were achieved as well as a targeted selectivity to a well-defined product, namely lactic acid.

1. A catalytic system comprising a transition metal compound on a solid carrier, wherein
a) the solid carrier is a surface-reacted calcium carbonate, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source; and
b) wherein the transition metal compound is selected from the group consisting of elemental Ni, elemental Ru, elemental Au, elemental Pd, elemental Pt, elemental Fe, elemental Cu and mixtures thereof;
and wherein the content of the transition metal element on the surface of the solid carrier is from 0.1 to 30 wt.-%, based on the dry weight of the solid carrier.

2. The catalytic system according to claim 1, wherein
the natural ground calcium carbonate is selected from the group consisting of marble, chalk, limestone, and mixtures thereof, or
the precipitated calcium carbonate is selected from the group consisting of precipitated calcium carbonates having an aragonitic, vateritic or calcitic crystal form, and mixtures thereof.

3. The catalytic system according to claim 1, wherein the at least one H₃O⁺ ion donor is selected from the group consisting of hydrochloric acid, sulphuric acid, sulphurous acid, phosphoric acid, citric acid, oxalic acid, an acidic salt, acetic acid, formic acid, and mixtures thereof,

4. The catalytic system according to claim 1, wherein the solid carrier has:
(i) a volume median particle size d₅₀ from 0.1 to 75 μm,
(ii) a volume top cut particle size d₉₈ from 0.2 to 150 μm, and/or
(iii) a specific surface area of from 10 m²/g to 200 m²/g, measured using nitrogen and the BET method.

5. The catalytic system according to claim 1, wherein the transition metal compound is preferably selected from the group consisting of elemental Ni, elemental Ru, elemental Au, elemental Fe, elemental Cu and mixtures thereof and most preferably is selected from the group consisting of elemental Ni, elemental Ru, elemental Au and mixtures thereof.

6. The catalytic system according to claim 1, wherein the content of the transition metal element on the surface of the solid carrier is in the range of from 0.25 to 25 wt. %, preferably from 0.5 to 20 wt. %, more preferably 1 to 15 wt. %, even more preferably from 2 to 10 wt. % and most preferably from 2.5 to 5 wt. %, based on the dry weight of the solid carrier.

7. A method for manufacturing a catalytic system comprising a transition metal compound on a solid carrier, the method comprising the following steps:
(a) providing at least one solid carrier, wherein the solid carrier is a surface-reacted calcium carbonate, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source;
(b) providing at least one transition metal reagent comprising Ni ions, Ru ions, Au ions, Pd ions, Pt ions, Fe ions, Cu ions and mixtures thereof in such an amount that the amount of said ions is from 0.1 to 30 wt.-%, based on the dry weight of the solid carrier;
(c) contacting the at least one solid carrier provided in step (a) and the transition metal reagent provided in step (b) to obtain a mixture comprising a solid carrier and a transition metal reagent; and
(d) calcining the mixture of step (c) at a temperature between 250° C. and 500° C.; and
(e) reducing the calcined catalytic system obtained from step (d) under H₂ atmosphere at a temperature between 100° C. and 500° C. for obtaining a catalytic system comprising a transition metal compound on the solid carrier, wherein the transition metal compound is selected from the group consisting of elemental Ni, elemental Ru, elemental Au, elemental Pd, elemental Pt, elemental Fe, elemental Cu and mixtures thereof.

8. The method according to claim 7, wherein the calcination step (d) is performed
(i) under air, N₂ atmosphere, Ar atmosphere, O₂ atmosphere or mixtures thereof and/or
(ii) at a temperature between 275° C. and 475° C.

9. The method according to claim 7, wherein the method further comprises a step of
(f) providing a solvent and contacting the at least one solid carrier provided in step (a) and/or the transition metal reagent provided in step (b) before or during step (c) in any order, wherein the solvent is a non-polar solvent, a polar solvent or a mixture thereof.

10. The method according to claim 9, wherein the method further comprises a step of (g) removing at least part of the solvent after step (c) and before step (d) by evaporation and/or filtration and/or centrifugation and/or spray drying to obtain a concentrated mixture.

11. The method according to claim 9, wherein the method further comprises step (h) of thermally treating the mixture of step (c) or the concentrated mixture of step (g) at a temperature between 25° C. and 200° C.

12. The method according to claim 7, wherein the transition metal reagent is selected from the group consisting of (NH₄)₂Ni(SO₄)₂, Ni(OCOCH₃)₂, NiBr₂, NiCl₂, NiF₂, Ni(OH)₂, NiI₂, Ni(NO₃)₂, Ni(ClO₄)₂, Ni(SO₃NH₂)₂, NiSO₄, K₂Ni(H₂IO₆)₂, K₂Ni(CN)₄, [Ru(NH₃)₆]Cl₂, [Ru(NH₃)₆]Cl₃, [Ru(NH₃)₅Cl]Cl₂, RuCl₃, Ru(NO)(NO₃), RuI₃, RuF₅, HAuCl₄, AuBr₃, AuCl, AuCl₃, Au(OH)₃, Aul, KAuCl₄, Pd(NO₃)₂, Pd(acac)₂, Na₂PdCl₄, Pd(OAc)₂, Pd(PPh₃)₄, PdCl₂(PPh₃)₂, (dppf)PdCl₂, (dppe)PdCl₂, (dppp)PdCl₂, (dppb)PdCl₂, PdCl₂, (C₃H₅PdCl)₂, bis(acetate)triphenylphosphine-palladium(II), Pd(dba)₂, Pd(H₂NCH₂CH₂NH₂)Cl₂, Na₂PtCl₆Pt(acac)₂, Na₂PtCl₄, H₂PtCl₆, (NH₄)₂[PtCl₆], PtO₂·H₂O, PtCl₄, Pt(NO₃)₄, Cu₂S, copper(I)-thiophene-2-carboxylate, CuBr, CuCN, CuCl, CuF, CuI, CuH, CuSCN, CuBr₂, CuCO₃, CuCl₂, CuF₂, Cu(NO₃)₂, Cu₃(PO₄)₂, Cu(OH)₂, CuI₂, CuS, CuSO₄, Cu₂(OAc)₄, (NH₄)₂Fe(SO₄)₂, FeBr₂, FeBr₃, FeCl₂, FeCl₃, FeF₂, FeF₃, FeI₂, Fe(NO₃)₃, FeC₂O₄, Fe₂(C₂O₄)₃, Fe(ClO₄)₂, FePO₄, FeSO₄, Fe(BF₄)₂, K₄Fe(CN)₆ and mixtures thereof.

13. A method of using a catalytic system according to claim 1 in a process comprising:
(A) providing one or more reactants;
(B) providing said catalytic system ;
(C) subjecting the one or more reactants provided in step (A) to a chemical reaction under air, O₂ atmosphere, H₂ atmosphere, or inert atmosphere at a temperature between 75 and 300° C. in the presence of the catalytic system provided in step (B).

14. The method according to claim 13, wherein the process further comprises step (D) of recovering and optionally recycling the catalytic system following the chemical reaction of step (C).

15. A catalyst comprising the catalyst system according to claim 1.

16. Granules, mouldings or extrudates comprising the catalytic system according to claim 1.

17. The catalytic system according to claim 3, wherein the at least one H₃O⁺ ion donor is phosphoric acid.

18. The catalytic system according to claim 4, wherein the solid carrier has:
(i) a volume median particle size d₅₀ from 1.5 to 15 μm, and
(ii) a volume top cut particle size d₉₈ from 3 to 30 μm, and
(iii) a specific surface area of from 30 m²/g to 100 m²/g, measured using nitrogen and the BET method.

19. The method according to claim 9 wherein the solvent is water.

20. The method according to claim 12 wherein the transition metal reagent is selected from the group consisting of Ni(NO₃)₂, RuNO(NO₃), HAuCl₄, Fe(NO₃)₃, Cu(NO₃)₂, Pd(NO₃)₂, and Pt(NO₃)₄.
